(19) United States
(12) Patent Application Publication
(10) Pub. No.: US 2011/0029186 A1
(43) Pub. Date: Feb. 3, 2011

(54) FAILURE DIAGNOSTIC INFORMATION GENERATING APPARATUS AND FAILURE DIAGNOSTIC INFORMATION GENERATING SYSTEM

(75) Inventor: Tomoyasu Ishikawa, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi ,Aichi-ken (JP)

(21) Appl. No.: 12/935,997

(22) PCT Filed: Apr. 2, 2009
(86) PCT No.: PCT/IB2009/000596

§ 371 Date: Oct. 1, 2010

(30) Foreign Application Priority Data
Apr. 2, 2008 (JP) 2008-096516

(51) Int. Cl. G06F 7/00

(52) U.S. Cl. 701/30

(57) ABSTRACT

A failure diagnostic information generating apparatus includes a repair information acquiring unit that acquires repair information indicating the content of repair or replacement conducted for a vehicle malfunction or a cause of the malfunction; an malfunction-time vehicle information acquiring unit that acquires malfunction-time vehicle information indicating a vehicle state detected when the malfunction occurs; an instruction information generating unit that generates instruction information, usable for future repair or replacement, on the basis of the repair information and the malfunction-time vehicle information; and a recurrence information acquiring unit that acquires recurrence information indicating whether the malfunction has recurred after the repair or replacement. It is determined, using the recurrence information, whether the malfunction has recurred after the repair or replacement. On the basis of the determination result, the instruction information generating unit determines whether to generate instruction information or whether to use generated instruction information for future repair or replacement.

### BACKGROUND OF THE INVENTION

1. Field of the Invention

The invention relates to a failure diagnostic information generating apparatus, a failure diagnostic information generating system, and the like, that generate instruction information used in vehicle failure diagnosis.

2. Description of the Related Art

For example, Japanese Patent No. 3799795 describes a vehicle diagnostic system in which failure diagnostic information based on malfunction that is found by vehicle self-diagnosis is wirelessly transmitted to an external base station and then the external base station provides information that prompts the user to repair the vehicle by mail (post). In the above vehicle diagnostic system, in order for the external base station to be able to acquire information that repair has been conducted, after the failure diagnostic information based on malfunction found by vehicle self-diagnosis is wirelessly transmitted from the vehicle toward the base station, if it is detected that the vehicle malfunction corresponding to the failure diagnostic information is eliminated (repaired), malfunction eliminated information that indicates elimination of the malfunction is transmitted from the vehicle to the base station.

Incidentally, not only in vehicle self-diagnosis or in external diagnosis, when failure of a vehicle is diagnosed, it is necessary to diagnose vehicle information (for example, patterns of variations in engine load, or the like) when the failure occurs. At this time, if pieces of past vehicle information at the time of failures had been acquired from a large number of vehicles are associated with causes of the failures to make a database, after that, when a similar vehicle information at the time of failure is acquired, failure cause information corresponding to the acquired vehicle information is retrieved from the database to thereby make it possible to easily identify the current failure cause (and, in addition, a method of repairing the failure).

However, because of a complex vehicle system, and the like, if a vehicle failure occurs, some of the causes (root causes) of the vehicle failures cannot be accurately identified. Even when repair or component replacement of the vehicle is conducted at a dealer, or the like, and then a failure is once eliminated, the failure may possibly recur again thereafter. In this case, eventually, the failure cause identified at the time of repair is erroneous. If the information of the above erroneous identification is accumulated in the above described database, there is a possibility that failure diagnostic accuracy may deteriorate.

### SUMMARY OF THE INVENTION

The invention provides a failure diagnostic information generating apparatus, a failure diagnostic information generating system, and the like, that are able to make a database of only pieces of reliable information by determining whether a malfunction has recurred after repair or component replacement of a vehicle.

A first aspect of the invention provides a failure diagnostic information generating apparatus. The failure diagnostic information generating apparatus includes: repair information acquiring means for acquiring repair information that indicates the content of repair or component replacement conducted in connection with a malfunction of a vehicle or a cause of the malfunction; malfunction-time vehicle information acquiring means for acquiring malfunction-time vehicle information that indicates a vehicle state detected when the malfunction occurs; instruction information generating means for generating instruction information, usable for future repair or component replacement, on the basis of the repair information and the malfunction-time vehicle information; and recurrence information acquiring means for acquiring recurrence information that indicates whether the malfunction has recurred after the repair or component replacement of the vehicle. When it is determined, on the basis of the recurrence information, that the malfunction has not recurred after the repair or component replacement of the vehicle, the instruction information generating means performs any one of the following (1) and (2). That is, (1) the instruction information generating means generates the instruction information on the basis of the repair information and malfunction-time vehicle information that are connected with the malfunction that has not recurred or (2) determines to use the instruction information for future repair or component replacement, the instruction information being generated by the instruction information generating means on the basis of the repair information and malfunction-time vehicle information that are connected with the malfunction that has not recurred.

In the first aspect, when it is determined that the malfunction has not recurred by the time when a predetermined period elapses from the repair or component replacement of the vehicle or by the time when the vehicle runs a predetermined distance, the instruction information generating means may generate the instruction information on the basis of the repair information and malfunction-time vehicle information that are connected with the malfunction that has not recurred or may determine to use the instruction information for future repair or component replacement, the instruction information being generated by the instruction information generating means on the basis of the repair information and malfunction-time vehicle information that are connected with the malfunction that has not recurred.

In the first aspect, when it is determined that the malfunction has recurred by the time when a predetermined period elapses from the repair or component replacement of the vehicle or by the time when the vehicle runs a predetermined distance, the instruction information generating means may not generate the instruction information on the basis of the repair information and malfunction-time vehicle information that are connected with the malfunction that has not recurred or may determine not to use the instruction information, which is generated by the instruction information generating means on the basis of the repair information and malfunction-time vehicle information that are connected with the malfunction that has not recurred, for future repair or component replacement.

In the above first aspect, only when it is determined that the malfunction has not recurred by the time when a predetermined period elapses from the repair or component replacement of the vehicle or by the time when the vehicle runs a predetermined distance, the repair information acquiring means may acquire the repair information connected with the malfunction that has not recurred, and the malfunction-time vehicle information acquiring means acquires the malfunction-time vehicle information, and the instruction information generating means may generate the instruction information on the basis of the acquired repair information and malfunction-time vehicle information.

In the first aspect, when it is determined that the malfunction has recurred by the time when a predetermined period elapses from the repair or component replacement of the vehicle or by the time when the vehicle runs a predetermined distance, the instruction information generating means may discard the repair information and malfunction-time vehicle information that are connected with the malfunction that has recurred and, when instruction information connected with the malfunction that has recurred has been generated, may discard the instruction information connected with the malfunction that has recurred.

In the first aspect, only when it is determined that the malfunction has not recurred by the time when a predetermined period elapses from the repair or component replacement of the vehicle or by the time when the vehicle runs a predetermined distance, the instruction information generating means may provide the instruction information connected with the malfunction that has not recurred to a vehicle repair support apparatus that is installed in at least any one of a vehicle, a dealer and a repair facility.

In the first aspect, the recurrence information acquiring means may acquire the recurrence information from at least any one of a vehicle, a dealer and a repair facility, or the recurrence information acquiring means may acquire post-repair vehicle information that indicates a vehicle state of the vehicle after the repair or component replacement of the vehicle from at least any one of a vehicle, a dealer and a repair facility and then may determine, on the basis of the acquired post-repair vehicle information, whether the malfunction has recurred to thereby acquire the recurrence information.

In the first aspect, the failure diagnostic information generating apparatus may further include repair support information generating means for generating repair support information useful for repair or component replacement to a new malfunction on the basis of malfunction-time vehicle information, acquired when the new malfunction occurs, and the instruction information.

In the first aspect, the repair support information may contain at least any one of information that indicates the content of repair or component replacement to be conducted and root cause information that indicates a cause of the new malfunction.

A second aspect of the invention provides a vehicle repair support apparatus installed in at least any one of a vehicle, a dealer and a repair facility. The vehicle repair support apparatus includes: instruction information acquiring means for acquiring the instruction information from the failure diagnostic information generating apparatus according to the first aspect; malfunction-time vehicle information acquiring means for acquiring malfunction-time vehicle information that indicates a vehicle state detected when a malfunction occurs in a vehicle; and repair support information output means for generating and outputs repair support information useful for repair or component replacement to the malfunction on the basis of the acquired malfunction-time vehicle information and the acquired instruction information.

A third aspect of the invention provides a vehicle repair support apparatus installed in at least any one of a vehicle, a dealer and a repair facility. The vehicle repair support apparatus includes repair support information output means for acquiring and outputs the repair support information from the failure diagnostic information generating apparatus according to the first aspect.

In the third aspect, the repair support information may contain at least any one of information that indicates the content of repair or component replacement to be conducted and root cause information that indicates a cause of the new malfunction.

A fourth aspect of the invention provides a vehicle repair support system. The vehicle repair support system includes: the failure diagnostic information generating apparatus according to the first aspect and the vehicle repair support apparatus according to the second or third aspect.

A fifth aspect of the invention provides a failure diagnostic information generating system. The failure diagnostic information generating system includes: the failure diagnostic information generating apparatus according to the first aspect; and a recurrence information providing apparatus. The recurrence information providing apparatus includes post-repair vehicle information acquiring means for acquiring post-repair vehicle information that indicates a vehicle state of the vehicle after the repair or component replacement of that vehicle; determining means for determining, on the basis of the acquired post-repair vehicle information, whether the malfunction has recurred; and transmitting means for generating the recurrence information on the basis of the result determined by the determining means and that transmits the generated recurrence information to the failure diagnostic information generating apparatus.

In the fifth aspect, only when the determining means determines that the malfunction has not recurred, the transmitting means may transmit the repair information and malfunction-time vehicle information, which are connected with the malfunction that has not recurred, to the failure diagnostic information generating apparatus, and the transmission of the repair information and malfunction-time vehicle information may serve as the recurrence information.

In the fifth aspect, the post-repair vehicle information acquiring means, the determining means and the transmitting means may be installed in at least any one of a vehicle, a dealer and a repair facility.

A sixth aspect of the invention provides a recurrence information providing apparatus. The recurrence information providing apparatus is used in the failure diagnostic information generating system according to fifth aspect.

A seventh aspect of the invention provides a failure diagnostic information generating method. The failure diagnostic information generating method includes: acquiring repair information that indicates the content of repair or component replacement conducted in connection with a malfunction of a vehicle or a cause of the malfunction; acquiring malfunction-time vehicle information that indicates a vehicle state detected when the malfunction occurs; acquiring recurrence information that indicates whether the malfunction has recurred after the repair or component replacement of the vehicle; and when it is determined, on the basis of the recurrence information, that the malfunction has not recurred, generating instruction information usable for future repair or component replacement on the basis of the repair information and the malfunction-time vehicle information.

An eighth aspect of the invention provides a database. The database holds the instruction information generated by the failure diagnostic information generating apparatus according to the first aspect.

A ninth aspect of the invention provides a database installed in at least any one of a vehicle, a dealer and a repair facility. The database holds the instruction information supplied from the failure diagnostic information generating apparatus according to the first aspect.

According to the aspects of the invention, it is possible to provide a failure diagnostic information generating apparatus, a failure diagnostic information generating system, and the like, that are able to make a database of only pieces of reliable information by determining whether a malfunction has recurred after repair or component replacement of a vehicle.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a functional configuration diagram that shows the basic functions of a vehicle repair support system according to embodiments of the invention;

FIG. 2 is a functional configuration diagram that shows the basic functions of the vehicle repair support system according to the embodiments of the invention;

FIG. 3 is a system configuration diagram that shows the relevant configuration of a vehicle repair support system according to a first embodiment of the invention;

FIG. 4A and FIG. 4B are a flowchart that shows the flow of a failure diagnostic support scheme implemented by the vehicle repair support system according to the first embodiment;

FIG. 5 is a view that shows an example of FFD;

FIG. 6 is a view that shows an example of DTC;

FIG. 7 is a view that shows an example of mining instruction data;

FIG. 8 is a view that shows an example of a mining method using the mining instruction data;

FIG. 9 is a view that shows an example of mining results;

FIG. 10 is a system configuration diagram that shows the relevant configuration of a vehicle repair support system according to a second embodiment of the invention;

FIG. 11A and FIG. 11B are a flowchart that shows the flow of a failure diagnostic support scheme implemented by the vehicle repair support system according to the second embodiment;

FIG. 12 is a system configuration diagram that shows the relevant configuration of a vehicle repair support system according to a third embodiment of the invention;

FIG. 13A and FIG. 13B are a flowchart that shows the flow of a failure diagnostic support scheme implemented by the vehicle repair support system according to the third embodiment;

FIG. 14 is a system configuration diagram that shows the relevant configuration of a vehicle repair support system according to a fourth embodiment of the invention; and

FIG. 15A and FIG. 15B are a flowchart that shows the flow of a failure diagnostic support scheme implemented by the vehicle repair support system according to the fourth embodiment.

### DETAILED DESCRIPTION OF EMBODIMENTS

Hereinafter, embodiments of the invention will be described with reference to the accompanying drawings.

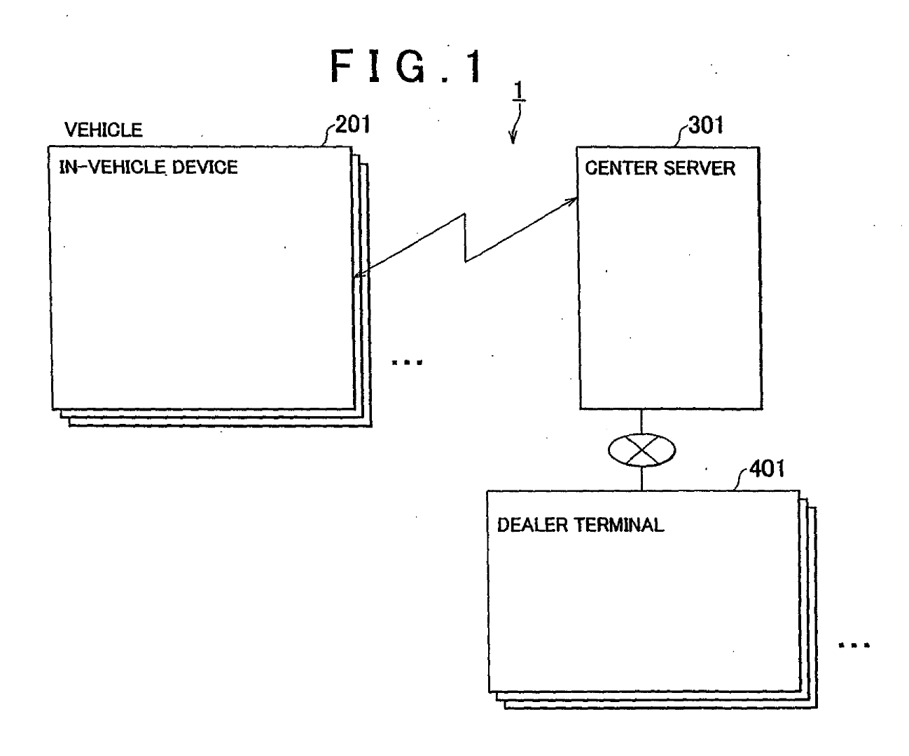

FIG. 1 is a functional configuration diagram that shows the basic functions of a vehicle repair support system 1 according to the embodiments of the invention. The vehicle repair support system 1 mainly includes in-vehicle devices 201, a center server 301, and dealer terminals 401. The in-vehicle devices 201 are mounted on vehicles. The center server 301 is arranged at a mining center. The dealer terminals 401 are managed by dealers or repair facilities (hereinafter, collectively referred to as “dealers”) at which repair or component replacement of a vehicle is conducted. A plurality of the dealer terminals 401 may be provided at the respective dealers. Each dealer terminal 401 is connected to the center server 301 through a selected communication line. The center server 301 may be formed of servers that are dispersedly arranged at multiple locations; however, in this case as well, the dispersedly arranged servers functionally cooperate to serve as the single center server 301. Note that as in the case of a second embodiment and a third embodiment, which will be described later, vehicle repair support systems 12 and 13 that do not necessarily require the dealer terminals 401 may also be implemented.

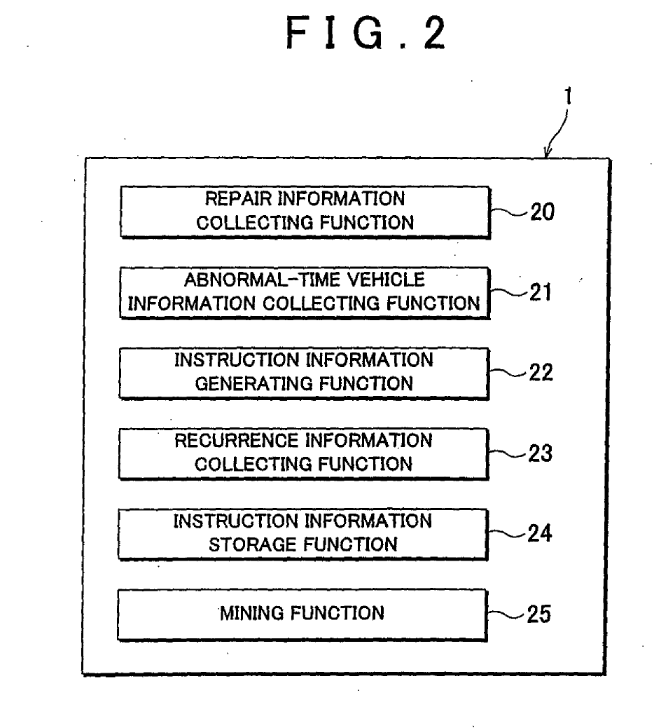

FIG. 2 is a functional configuration diagram that shows the basic functions of the vehicle repair support system 1. The vehicle repair support system 1 mainly has a repair information collecting function 20, an malfunction-time vehicle information collecting function 21, an instruction information generating function 22, a recurrence information collecting function 23, an instruction information storage function 24, and a mining function 25. The repair information collecting function 20 collects information that indicates the content of repair or component replacement conducted in accordance with a malfunction of the vehicle or information that indicates a cause of the malfunction (hereinafter, collectively referred to as “repair information”). The malfunction-time vehicle information collecting function 21 collects malfunction-time vehicle information that indicates a vehicle state detected when the malfunction occurs. The instruction information generating function 22 generates instruction information usable in future repair or component replacement on the basis of the repair information and the malfunction-time vehicle information that are collected in connection with the same malfunction. The recurrence information collecting function 23 acquires recurrence information that indicates whether the malfunction has recurred after repair or component replacement of the vehicle. The instruction information storage function 24 accumulates instruction information.

The instruction information generating function 22 operates only if the malfunction has not recurred after repair or component replacement of the vehicle, to generate instruction information. On the other hand, the instruction information generating function 22 may operate irrespective of whether a malfunction recurs after repair or component replacement of the vehicle. In this case, the generated instruction information is used only if the malfunction has not recurred after repair or component replacement of the vehicle. The generated instruction information is discarded if the malfunction has recurred after repair or component replacement of the vehicle.

The above described functions 20 to 25 will be described later in greater detail. The majority of the functions 20 to 25 is distributed mainly to the center server 301 and also to the in-vehicle device 201 of each vehicle and the terminal 401 at each dealer. FIG. 1 shows a state where the arrangement of the functions 20 to 25 is not determined. The vehicle repair support system including the arrangement of the functions 20 to 25 is termed a vehicle repair support system 1. The arrangement of the functions 20 to 25 may be implemented in various forms, and some typical examples of arrangement will be described below in first to fourth embodiments. Depending on the arrangement of the functions 20 to 25, the vehicle repair support systems according to the embodiments are respectively termed vehicle repair support systems 11 to 14.

The vehicle repair support system 11 has the arrangement of the first embodiment so that the above described functions 20 to 25 are mainly implemented by the center server 301.

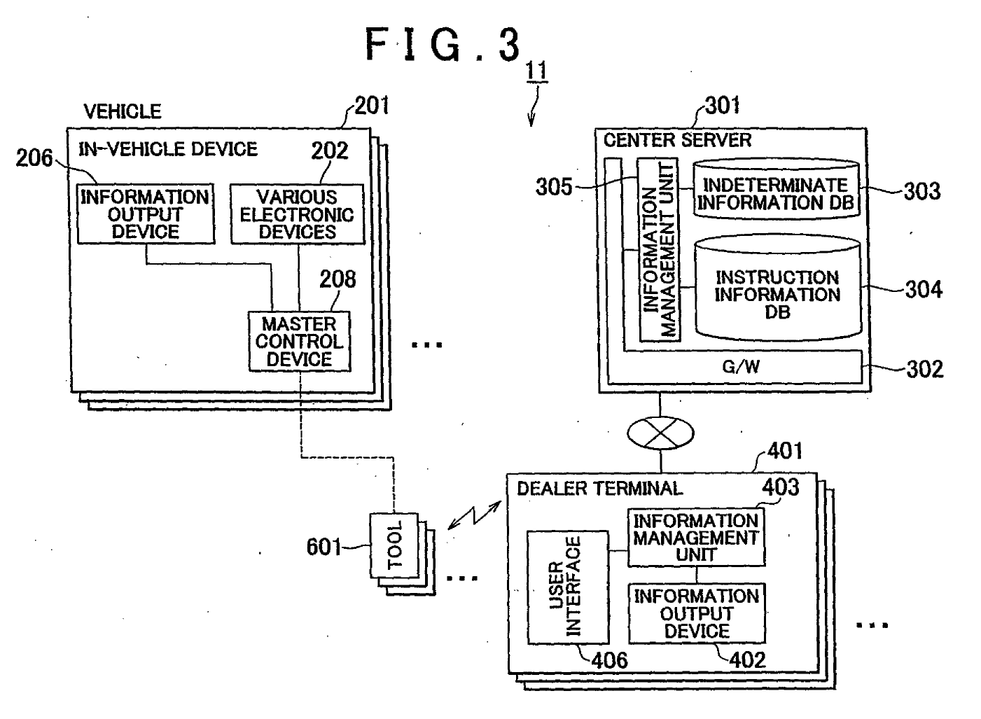

FIG. 3 is a system configuration diagram that shows the relevant configuration of the vehicle repair support system 11. The vehicle repair support system 11 of the present embodiment includes in-vehicle devices 201, a center server 301, and dealer terminals 401. The in-vehicle devices 201 are mounted on vehicles. The center server 301 is arranged at a mining center. The dealer terminals 401 are managed by dealers at which repair or component replacement of a vehicle is conducted.

As shown in FIG. 3, each in-vehicle device 201 includes various electronic devices 202, an information output device 206 and a master control device 208. The master control device 208 is connected to a plurality of the in-vehicle electronic devices 202 through a bus, such as a controller area network (CAN), a body electronics area network (BEAN, a kind of bidirectional multiplex communication network) and a local interconnect network (LIN). The various electronic devices 202 may include various ECUs, sensors, and the like. The information output device 206 is, for example, a lamp in an indicator (lamp for indicating malfunction) or a display.

The center server 301 includes a network gateway 302, an indeterminate information database 303, an instruction information database 304 and an information management unit 305.

Each dealer terminal 401 includes an information output device 402, an information management unit 403 and a user interface 406.

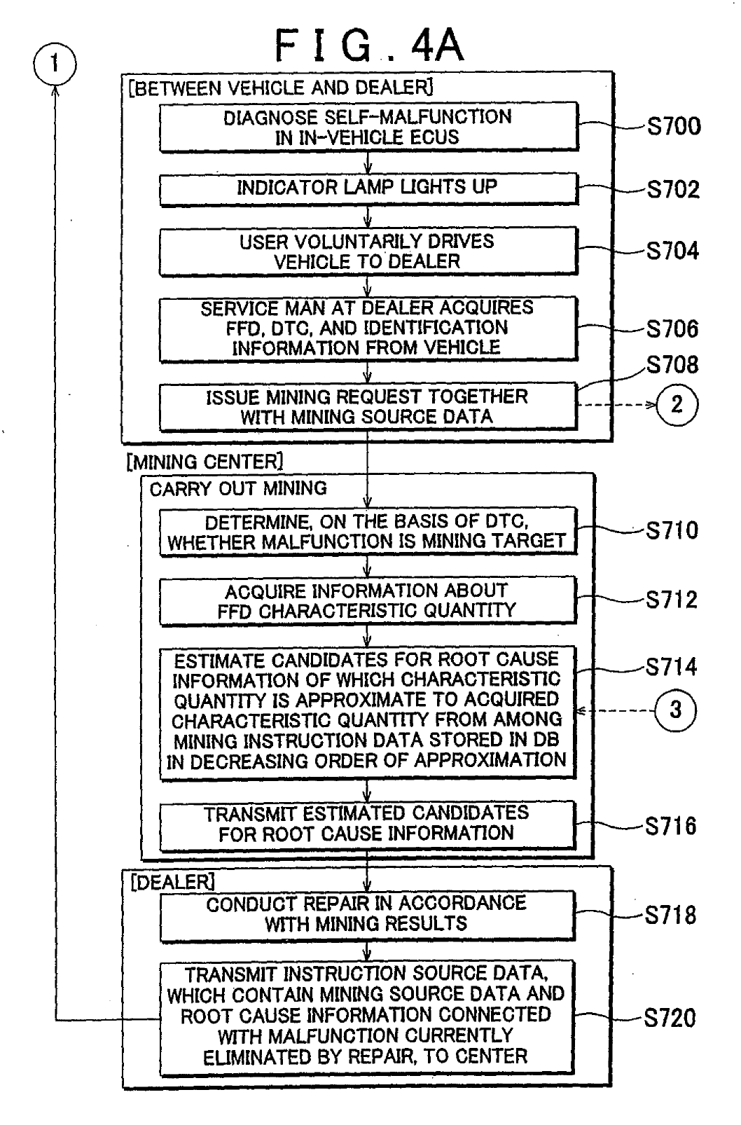

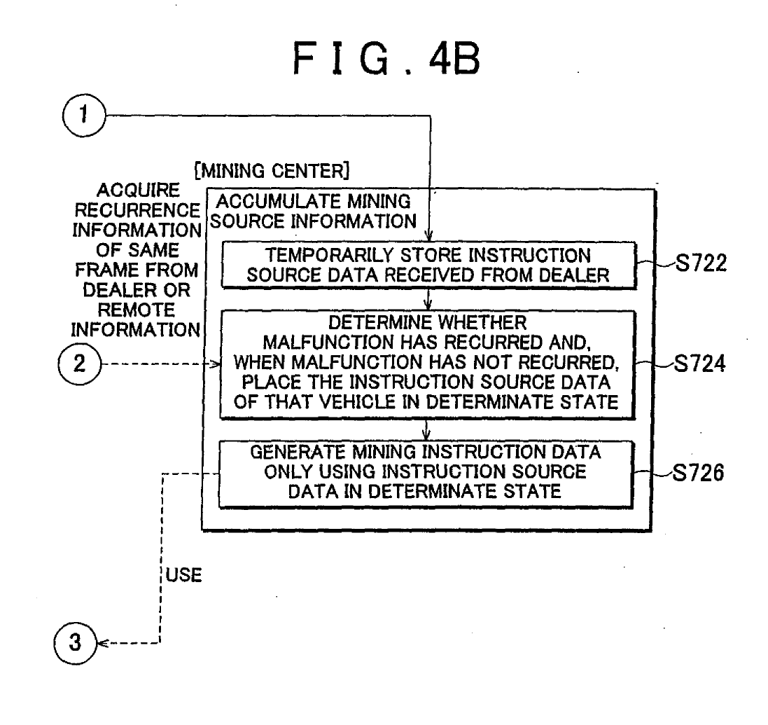

FIG. 4A and FIG. 4B are a flowchart that shows the flow of a failure diagnostic support scheme implemented by the vehicle repair support system 11 according to the first embodiment.

In step 700, in-vehicle ECUs, which are elements of the various electronic devices 202 of the in-vehicle device 201 of a vehicle, carry out self-malfunction diagnosis of the in-vehicle device 201. The self-malfunction diagnosis in the in-vehicle ECUs may be implemented in various forms, and may employ a selected appropriate method. When the in-vehicle ECUs detect a self-malfunction (for example, a malfunction in systems governed by the in-vehicle ECUs), the corresponding in-vehicle ECU transmits a warning signal to the master control device 208.

In step 702, the master control device 208 of the in-vehicle device 201 of the vehicle lights or blinks a warning lamp (typically, an indicator lamp in the indicator) of the information output device 206 in response to the warning signal transmitted from any one of the in-vehicle ECUs, which are elements of the various electronic devices 202.

In step 704, a vehicle user who recognizes blinking of the warning lamp voluntarily drives the vehicle to a dealer and requests the dealer for check and repair.

In step 706, a service man at the dealer uses a tool 601 (see FIG. 3) to acquire freeze frame data (FFD), a diagnostic trouble code (DTC) and identification information from the vehicle.

The tool 601 is typically supplied from a carmaker to each dealer. The tool 601 is presumably used by a technical service man at a dealer and may be a compact terminal that can be carried with a person for operation. Note that the tool 601 may require authentication, such as password input or ID check, for use in order to prevent an unauthorized person from using the tool 601. When the tool 601 is connected to a predetermined connection terminal provided for a vehicle, the tool 601 acquires FFD, a DTC and identification information from the vehicle. The tool 601 may acquire various pieces of information through wireless communication (for example, narrow-band communication).

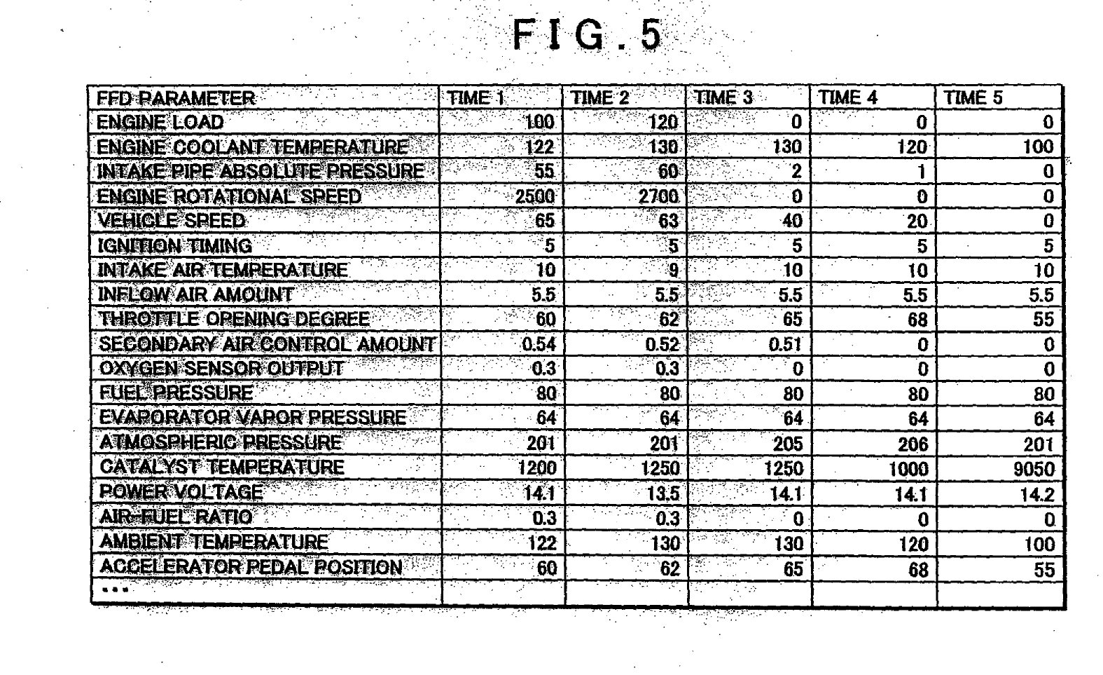

The FFD are pieces of information that indicate a vehicle state detected when a malfunction occurs. The FFD may contain the operating states of the various electronic devices 202 or time series (patterns of) values detected by sensors. In addition, the FFD may contain wide range of information, such as operating data (operational data and/or freeze frame data of systems and electronic components that constitute the systems) at the time, before and after a malfunction occurs, a time at which a failure (malfunction) occurs, and a vehicle location and vehicle speed at that time. For example, the FFD may contain various pieces of information as shown in FIG. 5.

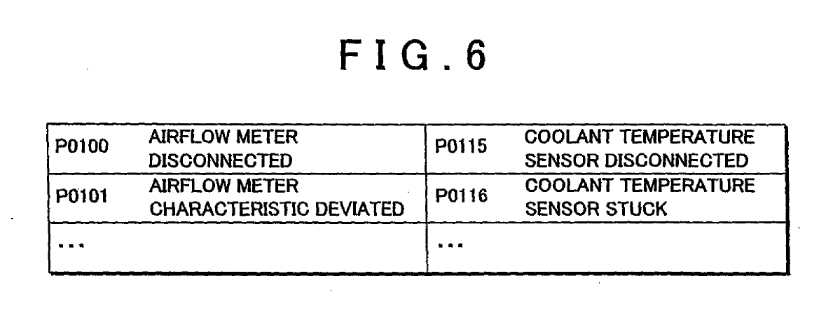

The DTC is information that indicates a type of warning signal (diagnostic information), and may, for example, contain various pieces of information as shown in FIG. 6. The identification information is vehicle identification information, and may be, for example, a body frame number.

In step 708, the information management unit 403 of the dealer terminal 401 transmits the FFD, DTC and identification information, acquired by the tool 601 in step 706, to the center server 301 as mining source data together with a mining request signal. Note that the mining source data and the mining request signal may be directly transmitted from the tool 601 to the center server 301.

In step 710, the information management unit 305 of the center server 301 determines, on the basis of the DTC in the mining source data supplied from the dealer terminal 401, whether the malfunction is a mining target. For example, the information management unit 305 accesses the instruction information database 304 to determine whether a piece of mining instruction data corresponding to the current DTC is present in the instruction information database 304. Note that the case in which no piece of mining instruction data corresponding to the current DTC is present may possibly occur during a short period of time since the database starts accumulating data, such as immediately after operation of the present system is started. The following description refers to the case in which the malfunction is a mining target. If the malfunction is not a mining target, the center server 301 may provide notification that mining is not possible at the moment to the dealer terminal 401. In this case, at the dealer, the service man identifies the root cause of the malfunction by a selected method to repair the vehicle, and then carries out step 720, which will be described later, after the repair.

In step 712, the information management unit 305 of the center server 301 acquires the characteristic quantity of the FFD (FFD characteristic quantity) on the basis of the mining source data supplied from the dealer terminal 401. The FFD characteristic quantity may contain characteristic variations in the time series data of the FFD or the patterns of the variations. For example, in the case of the FFD shown in FIG. 5, the information management unit 305 acquires information that an engine load, an intake pipe absolute pressure, an engine rotational speed, an oxygen sensor output and an air-fuel ratio each change from time 2 to time 3.

In step 714, the information management unit 305 of the center server 301 extracts pieces of data that are the most approximate to the currently acquired FFD characteristic quantity from the mining instruction data in the instruction information database 304, and estimates pieces of root cause information connected with the mining instruction data as candidates for the root cause information corresponding to the current malfunction in decreasing order of the degree of approximation.

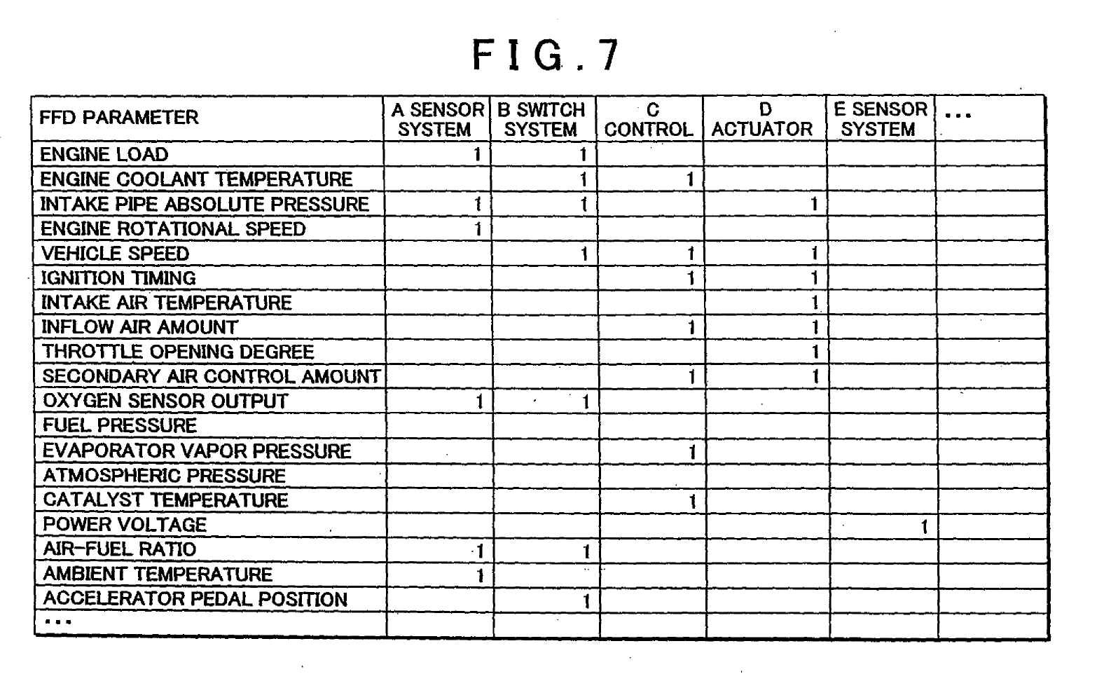

Here, the mining instruction data are used to derive root cause information (information that indicates the root cause of the malfunction) from the FFD, and how the mining instruction data are generated will be described later. The mining instruction data are generated so that the FFD characteristic quantity corresponding to root cause information is expressed by parameters, for example, as shown in FIG. 7. The mining instruction data shown in FIG. 7 indicate that, for example, when the root cause information indicates a failure of an A sensor system, the FFD characteristic quantity appears in engine load, intake pipe absolute pressure, engine rotational speed, oxygen sensor output, air-fuel ratio and ambient temperature.

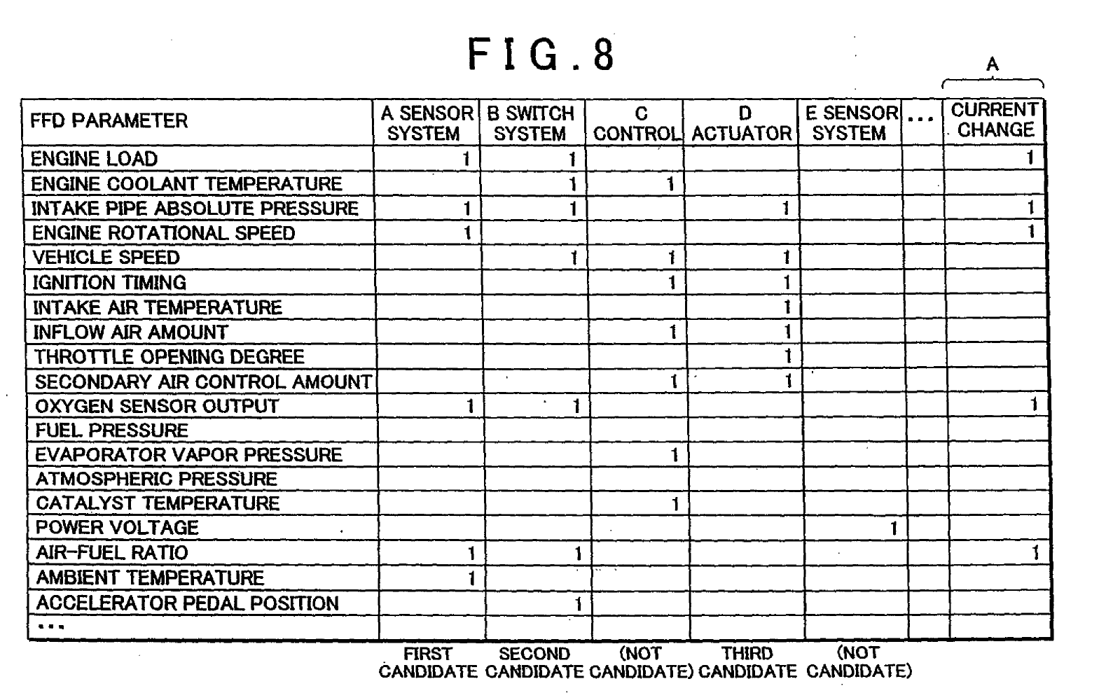

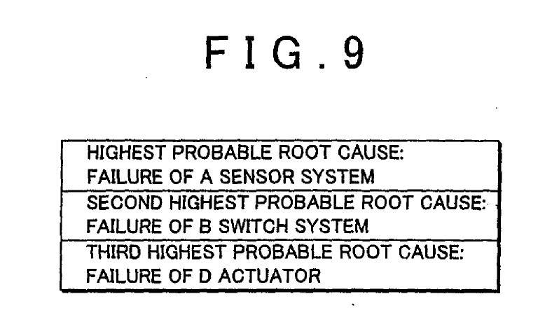

In the case of the FFD shown in FIG. 5, when the FFD characteristic quantity is expressed by parameters, the FFD characteristic quantity has the patterns shown at the column indicated by A in FIG. 8. In this case, as shown in FIG. 8, the most approximate FFD characteristic quantity corresponds to the root cause information of the A sensor system. The second approximate FFD characteristic quantity corresponds to the root cause information of a B switch system. The third approximate FFD characteristic quantity corresponds to the root cause information of a D actuator. Thus, as shown in FIG. 9, a failure of the A sensor system, a failure of the B switch system, and a failure of the D actuator are estimated as candidates for the root cause information in the stated order.

In step 716, the information management unit 305 of the center server 301 transmits the estimated candidates for the root cause information (mining results) to the dealer terminal 401 from which the mining request is issued.

In step 718, the information management unit 403 of the dealer terminal 401 outputs the mining results, received from the center server 301, through the information output device 402. The information output device 402 is, for example, a display. In this case, the mining results are displayed on the information output device 402. The service man at the dealer refers to the mining results to conduct repair. The repair is conducted until the malfunction is eliminated at that moment. However, as will be described later, the accuracy of the mining results increases as the mining instruction data are accumulated in the instruction information database 304. This increases reliability of repair (that is, the likelihood of recurrence of the malfunction after repair decreases) and, therefore, prevents a situation in which the root cause of the malfunction cannot be identified causing the repair of the vehicle to take a long time.

In step 720, the information management unit 403 of the dealer terminal 401 transmits instruction source data to the center server 301. The instruction source data contain a set of the mining source data and the root cause information connected with the malfunction that is currently eliminated by repair. Note that the mining source data have been already transmitted to the center server 301 (see step 708). Thus, the root cause information connected with the malfunction that is currently eliminated by repair may be transmitted to the center server 301 so that the root cause information can be associated with the already transmitted mining source data. In addition, the root cause information transmitted in step 720 is input by the service man (or an assistant to the service man, a manager, or the like, the same applies to the following description) to the dealer terminal 401 through the user interface 406.

In step 720, when the root cause information (including candidates) taught by the mining results is inappropriate, that is, when it is found from a repair that the root cause is different from the taught root cause information, the found root cause information is transmitted to the center server 301. In addition, it is also applicable that, when the root cause information (particularly, a first candidate) taught by the mining results is appropriate as well, that root cause information is transmitted to the center server 301.

In step 722, the information management unit 305 of the center server 301 temporarily stores the instruction source data, received from the dealer terminal 401 in step 720, in the indeterminate information database 303. Note that the temporarily stored instruction source data are initially placed in indeterminate state, and the instruction source data are not used to generate mining instruction data until the instruction source data are placed in determinate state, as will be described later.

In step 724, the information management unit 305 of the center server 301 determines whether the same malfunction has recurred in the same vehicle after the current repair, and changes the instruction source data of that vehicle to a determinate state when the same malfunction has not recurred. On the other hand, when the same malfunction has recurred, the information management unit 305 deletes (discards) the instruction source data of that vehicle from the indeterminate information database 303.

In step 724, the information management unit 305 may determine whether the malfunction has recurred using the mining source data (see step 708) transmitted from a vehicle, where necessary, each time a malfunction occurs. For example, when the information management unit 305 receives mining source data, the information management unit 305 searches the indeterminate information database 303 for instruction source data having the same identification information and DTC as the identification information and DTC of the mining source data. As a result of the searching, when no instruction source data having the same identification information and DTC are present, the information management unit 305 determines that the malfunction is new. On the other hand, as a result of the searching, when the instruction source data having the same identification information and DTC are present, the information management unit 305 determines that the malfunction has recurred.

In addition, it is also applicable that, in step 724, the information management unit 305, for example, acquires check results at the time of a periodic check, conducted at an interval from repair, from the in-vehicle device 201 and/or the dealer terminal 401, and determines whether the malfunction has recurred on the basis of the acquired check results.

In addition, in step 724, the information management unit 305 desirably acquires information about date and time of the previous repair or mileage (in this case, these pieces of information are contained in the mining source data), and determines whether the malfunction has recurred by the time when a predetermined period T (days) elapses from the previous repair or by the time when the vehicle runs a predetermined distance L (km). In this case, it is applicable that, when the information management unit 305 does not receive the same identification information and DTC as those of the instruction source data in the indeterminate information database 303 by the time when a predetermined period T (days) elapses from the previous repair or by the time when the vehicle runs a predetermined distance L (km), the management unit 305 changes the corresponding instruction source data to a determinate state. The predetermined period T (days) and the predetermined distance L (km) may be substantially associated with the timing of a periodic check conducted for determination after repair, and may be changed on the basis of the content of repair or malfunction.

In step 726, the information management unit 305 of the center server 301 uses only the determinate instruction source data among the instruction source data that are temporarily stored in the indeterminate information database 303 to generate mining instruction data. The information management unit 305 stores the generated mining instruction data in the instruction information database 304 in order to use the data for future mining (see steps 710 to 716). Note that even when the mining instruction data are generated, the determinate instruction source data used for generating the mining instruction data may still be stored in the indeterminate information database 303.

In step 726, various methods of generating mining instruction data from instruction source data may be employed and an appropriate method may be chosen from the various methods. For example, the mining instruction data may be instruction source data themselves. Alternatively, the mining instruction data may be generated so that the FFD characteristic quantity of instruction source data (in determinate state) is expressed by parameters and then the parameters are associated with root cause information, as shown in FIG. 7. Here, the mining instruction data shown in FIG. 7 show that a parameter “1” indicates an item that experiences a characteristic (variation) in FFD in response to a malfunction and a parameter “0” indicates an item that experiences no characteristic (variation) in FFD in response to a malfunction.

In step 726, when a single piece of instruction source data temporarily stored in the indeterminate information database 303 is placed in determinate state, the information management unit 305 may generate mining instruction data on the basis of the single piece of instruction source data in determinate state. Alternatively, mining instruction data may be generated by collectively using a plurality of pieces of instruction source data (in determinate state) having the same root cause information. In the latter case, it is applicable that, at the time when a predetermined number of pieces of instruction source data in determinate state with the same root cause information are accumulated, mining instruction data corresponding to that root cause information are generated. In addition, in the latter case, it is also applicable that, each time a piece of instruction source data in determinate state with the same root cause information is newly added, mining instruction data are generated (updated) by collectively using a plurality of pieces of instruction source data (in determinate state), acquired up to the present moment, with the same root cause information. In addition, in the latter case, it is also applicable that only a plurality of pieces of instruction source data in determinate state with the same root cause information in connection with vehicles of the same type, vehicles equipped with the same system, or vehicles of the same destination are used to generate mining instruction data corresponding to that root cause information. In this case, in correspondence with this, mining also uses the mining instruction data connected with vehicles of a similar type, or the like.

According to the first embodiment as described above, the following advantageous effects may be specifically obtained.

According to the first embodiment, as described above, instruction source data transmitted to the center server 301 are used to generate mining instruction data that are used for future mining (and repair based on the mining results) after it is determined whether the malfunction has recurred. That is, the instruction source data transmitted to the center server 301 are used to generate mining instruction data only if the malfunction has not recurred after repair. The instruction source data are discarded without using the data if the malfunction has recurred after repair. Thus, according to the first embodiment, by taking into consideration recurrence of malfunction, it is possible to generate mining instruction data using only accurate instruction source data. As a result, reliability (accuracy) of mining instruction data improves and, therefore, reliability (accuracy) of mining results improves.

The vehicle repair support system 12 has the arrangement of the second embodiment so that the above described functions 20 to 25 are mainly implemented by the center server 301 as in the case of the first embodiment. The difference between the first embodiment and the second embodiment is that a mining request is issued from a dealer side in the first embodiment, whereas a mining request is issued from a vehicle side in the second embodiment.

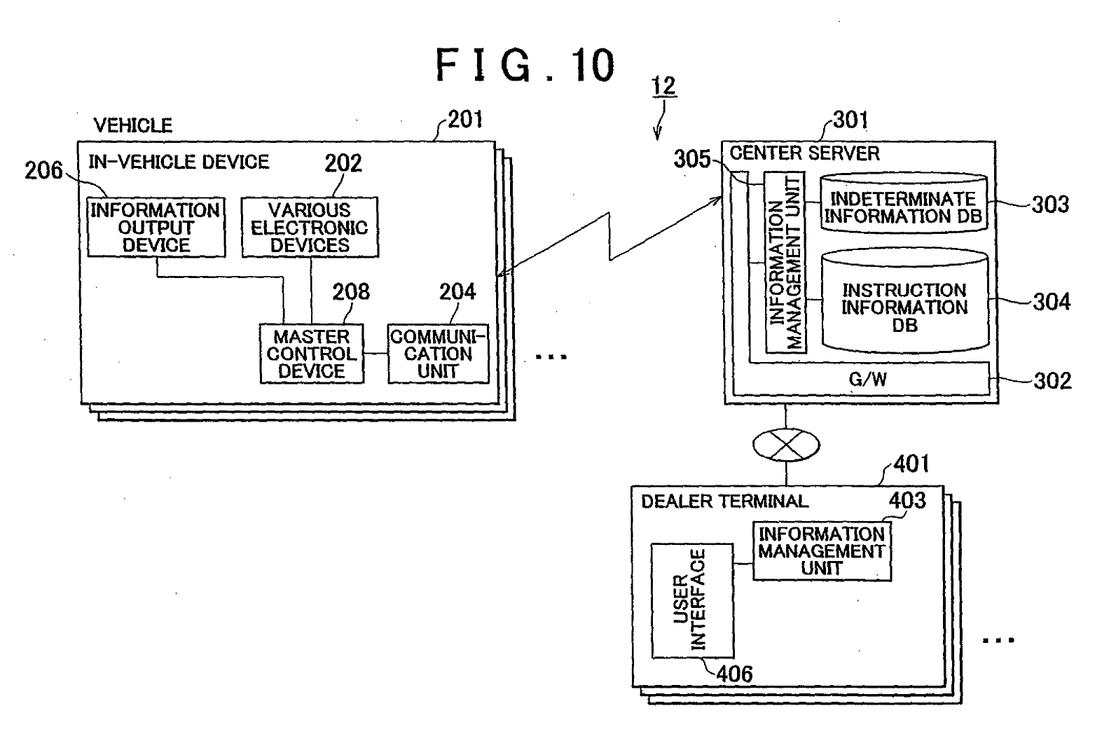

FIG. 10 is a system configuration diagram that shows the relevant configuration of the vehicle repair support system 12. Like reference numerals denote like components to those of the first embodiment, and the description thereof is omitted where appropriate.

As shown in FIG. 10, each in-vehicle device 201 includes the various electronic devices 202, a communication unit 204, the information output device 206 and the master control device 208. The center server 301 includes the network gateway 302, the indeterminate information database 303, the instruction information database 304 and the information management unit 305. Each dealer terminal 401 includes the information management unit 403 and the user interface 406.

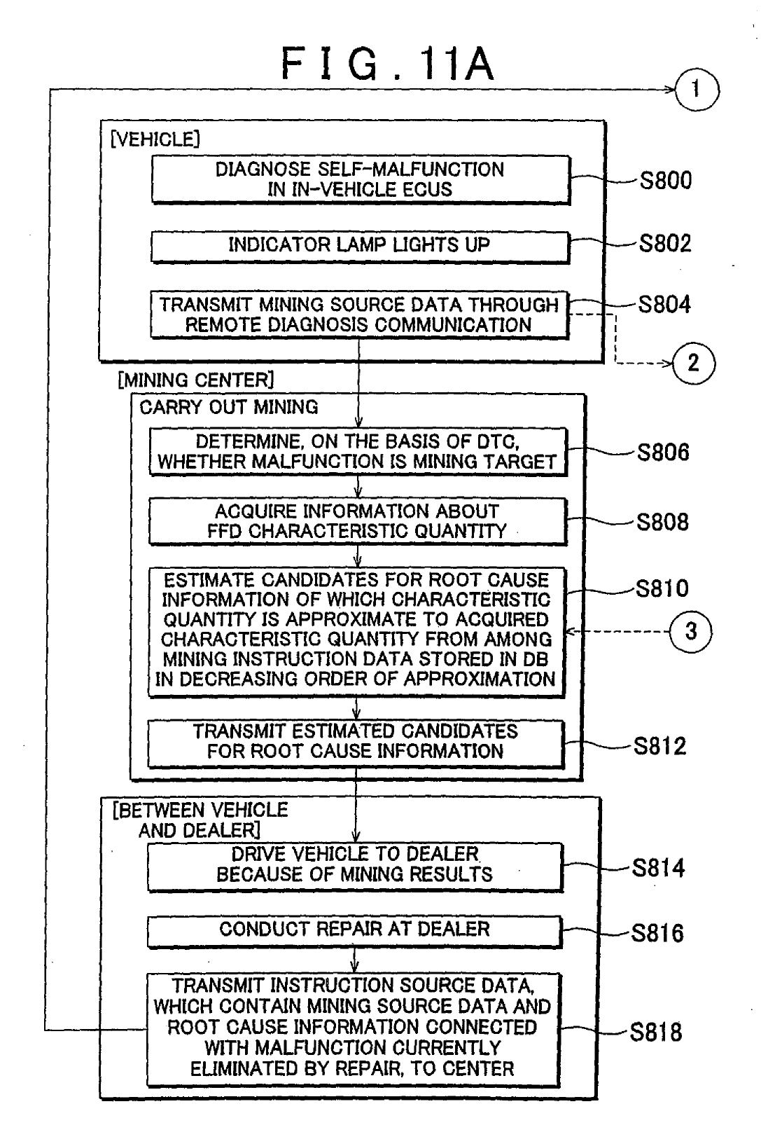

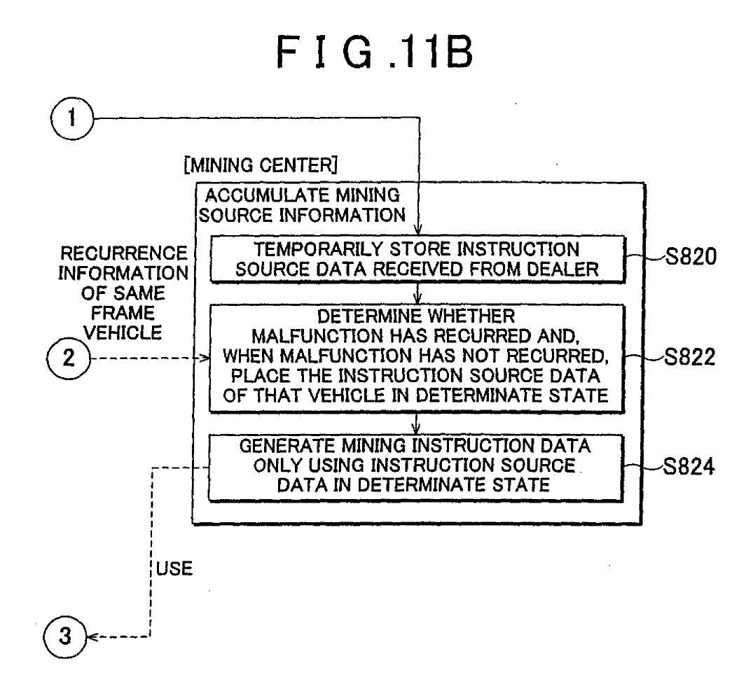

FIG. 11A and FIG. 11B are a flowchart that shows the flow of a failure diagnostic support scheme implemented by the vehicle repair support system 12 according to the second embodiment.

In step 800, in-vehicle ECUs, which are elements of the various electronic devices 202 of the in-vehicle device 201 of a vehicle, carry out self-malfunction diagnosis of the in-vehicle device 201. When the in-vehicle ECUs detect self-malfunction, the in-vehicle ECUs transmit a warning signal to the master control device 208.

In step 802, the master control device 208 of the in-vehicle, device 201 of the vehicle lights or blinks a warning lamp (typically, an indicator lamp in the indicator) of the information output device 206 in response to the warning signal transmitted from any one of the in-vehicle ECUs, which are elements of the various electronic devices 202.

In step 804, the master control device 208 of the in-vehicle device 201 of the vehicle generates mining source data that contain FFD and a DTC, acquired in connection with the current warning signal, and identification information, and then transmits the generated mining source data together with a mining request signal to the center server 301 through the communication unit 204.

In step 806, the information management unit 305 of the center server 301 determines, on the basis of the DTC in the mining source data supplied from the in-vehicle device 201, whether the malfunction is a mining target. For example, the information management unit 305 accesses the instruction information database 304 to determine whether a piece of mining instruction data corresponding to the current DTC is present in the instruction information database 304. In the present embodiment, the following description refers to the case in which the malfunction is a mining target. If the malfunction is not a mining target, the center server 301 may transmit notification that mining is not possible to the in-vehicle device 201 of the vehicle. Receiving the notification, the master control device 208 of the in-vehicle device 201 may provide notification that mining is not possible to a user through the information output device 206. In this case, when the user who receives the notification drives the vehicle to a dealer, a service man identifies the root cause of the malfunction by a selected method to repair the vehicle at the dealer, and then carries out step 818, which will be described later, after the repair.

In step 808, the information management unit 305 of the center server 301 acquires the FFD characteristic quantity on the basis of the mining source data supplied from the in-vehicle device 201. The process in step 808 may be similar to the process described in regard to step 712 of FIG. 4A in the above described first embodiment.

In step 810, the information management unit 305 of the center server 301 extracts pieces of data that are the most approximate to the currently acquired FFD characteristic quantity from the mining instruction data in the instruction information database 304, and estimates pieces of root cause information connected with the mining instruction data as candidates for the root cause information corresponding to the current malfunction in decreasing order of the degree of approximation. The process of step 810 may be similar to the process described in regard to step 714 of FIG. 4A in the above described first embodiment.

In step 812, the information management unit 305 of the center server 301 transmits the estimated candidates for the root cause information (mining results) to the in-vehicle device 201 of the vehicle, from which the mining request is issued. Note that, together with the mining results, information that prompts the vehicle user to repair the vehicle and/or information that advises a location of a dealer, or the like, may also be transmitted to the in-vehicle device 201 of the vehicle. As the mining results, and the like, are transmitted to the in-vehicle device 201 in this way, the master control device 208 outputs the mining results, and the like, through the information output device 206 (for example, display) (see FIG. 9). Note that the mining results may also be supplied to a dealer terminal 401 located at a dealer to which the vehicle is driven for repair when a request is issued from the dealer terminal 401.

In step 814, the vehicle user who sees the mining results voluntarily drives the vehicle to a dealer and requests the dealer for check and repair. At this time, the user shows the mining results, output onto the information output device 206, to a service man at the dealer in order to facilitate repair.

In step 816, the service man at the dealer refers to the mining results to conduct repair. The repair is conducted until the malfunction is eliminated at that moment. However, as will be described later, the accuracy of the mining results increases as the mining instruction data are accumulated in the instruction information database 304. This increases reliability of repair and, therefore, prevents a situation in which the root cause of malfunction cannot be identified causing the repair of the vehicle to take a long time.

In step 818, the information management unit 403 of the dealer terminal 401 transmits instruction source data to the center server 301. The instruction source data contain the mining source data and the root cause information connected with the malfunction that is currently eliminated by repair. Note that the mining source data have been already transmitted to the center server 301 (see step 804). Thus, the root cause information connected with the malfunction that is currently eliminated by repair may be transmitted to the center server 301 so that the root cause information can be associated with the already transmitted mining source data. In addition, the root cause information transmitted in step 818 is input by the service man to the dealer terminal 401 through the user interface 406. Alternatively, the root cause information may be transmitted from the in-vehicle device 201 to the center server 301 so that the root cause information can be associated with the already transmitted mining source data. In this case, the root cause information may be input by the service man through the user interface (not shown) of the in-vehicle device 201 or may be input by the user through the user interface (not shown) of the in-vehicle device 201. Note that in this case, the dealer terminal 401 at the dealer is not necessary and, therefore, the dealer terminal 401 may be omitted.

In step 818, when the root cause information (including candidates) taught by the mining results is inappropriate, that is, when it is found from a repair that the root cause is different from the taught root cause information, the found root cause information is transmitted to the center server 301. In addition, it is also applicable that, when the root cause information (particularly, a first candidate) taught by the mining results is appropriate as well, that root cause information is transmitted to the center server 301.

In step 820, the information management unit 305 of the center server 301 temporarily stores the instruction source data, received from the dealer terminal 401 (or the in-vehicle device 201) in step 818, in the indeterminate information database 303. Note that the temporarily stored instruction source data are initially placed in indeterminate state, and the instruction source data are not used to generate mining instruction data until the instruction source data are placed in determinate state, as will be described later.

In step 822, the information management unit 305 of the center server 301 determines whether the same malfunction has recurred in the same vehicle after the current repair, and changes the instruction source data of that vehicle to a determinate state when the same malfunction has not recurred. On the other hand, when the same malfunction has recurred, the information management unit 305 deletes (discards) the instruction source data of that vehicle from the indeterminate information database 303. The process in step 822 may be similar to the process described in regard to step 724 of FIG. 4B in the above described first embodiment.

In step 824, the information management unit 305 of the center server 301 uses only the determinate instruction source data among the instruction source data that are temporarily stored in the indeterminate information database 303 to generate mining instruction data. The information management unit 305 stores the generated mining instruction data in the instruction information database 304 in order to use the data for future mining (see steps 806 to 812). The process in step 824 may be similar to the process described in regard to step 726 of FIG. 4B in the above described first embodiment.

According to the above described second embodiment, as in the case of the above described first embodiment, mining instruction data are generated only using accurate instruction source data. As a result, reliability (accuracy) of mining instruction data improves and, therefore, reliability (accuracy) of mining results improves.

The vehicle repair support system 13 has the arrangement of the third embodiment so that the above described functions 20 to 24 are mainly implemented by the center server 301 as in the case of the first embodiment. The third embodiment mainly differs from the first embodiment in that the mining function 25 is mainly implemented at a vehicle side.

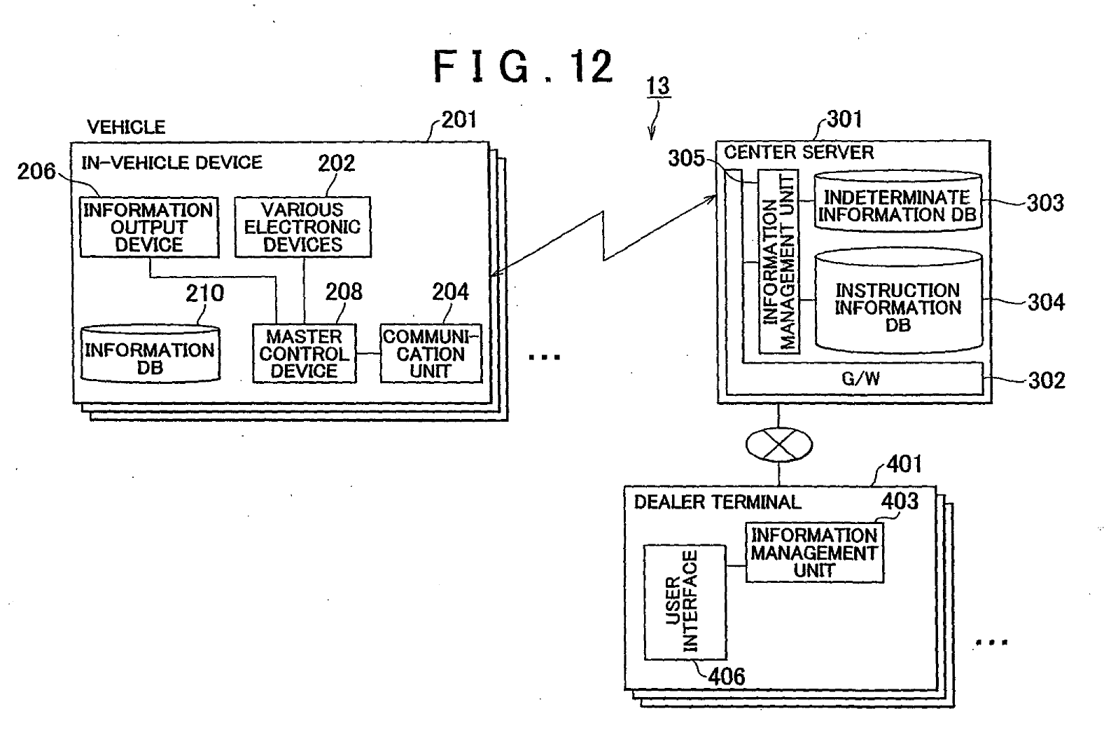

FIG. 12 is a system configuration diagram that shows the relevant configuration of the vehicle repair support system 13. Like reference numerals denote like components to those of the first embodiment, and the description thereof is omitted where appropriate.

As shown in FIG. 12, each in-vehicle device 201 includes the various electronic devices 202, the communication unit 204, the information output device 206, the master control device 208 and an information database (DB) 210. The information database 210 stores mining instruction data acquired through downloading from the center server 301, as will be described later. The center server 301 includes the network gateway 302, the indeterminate information database 303, the instruction information database 304 and the information management unit 305. Each dealer terminal 401 includes the information management unit 403 and the user interface 406.

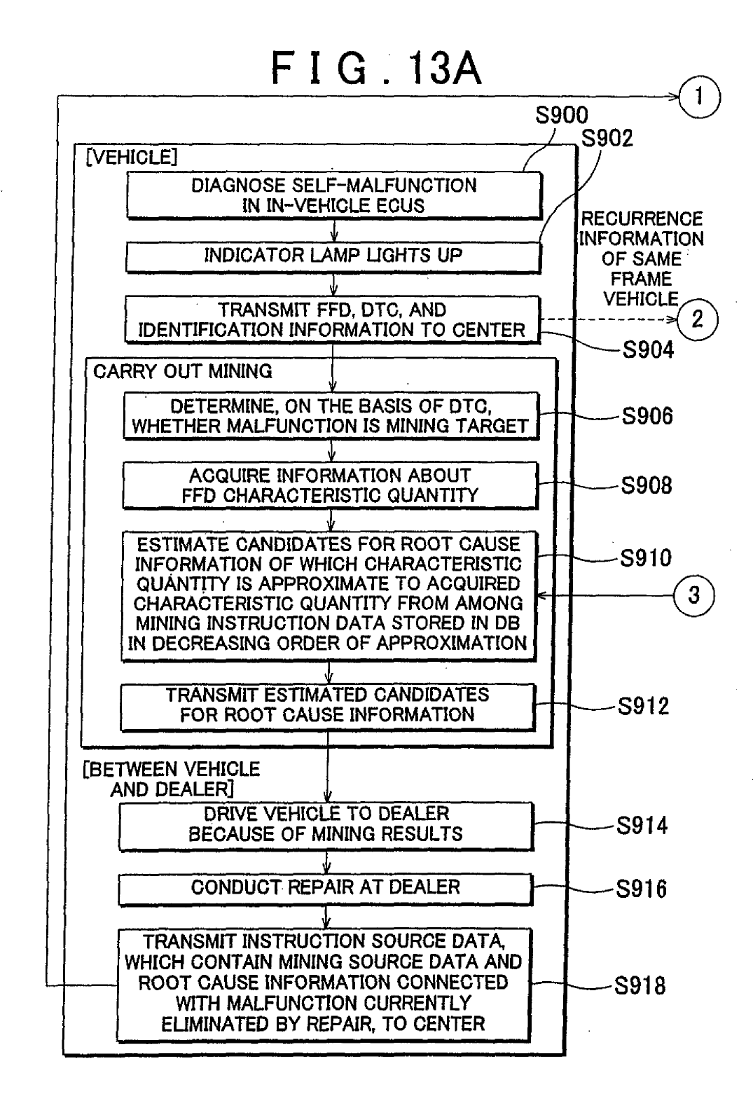

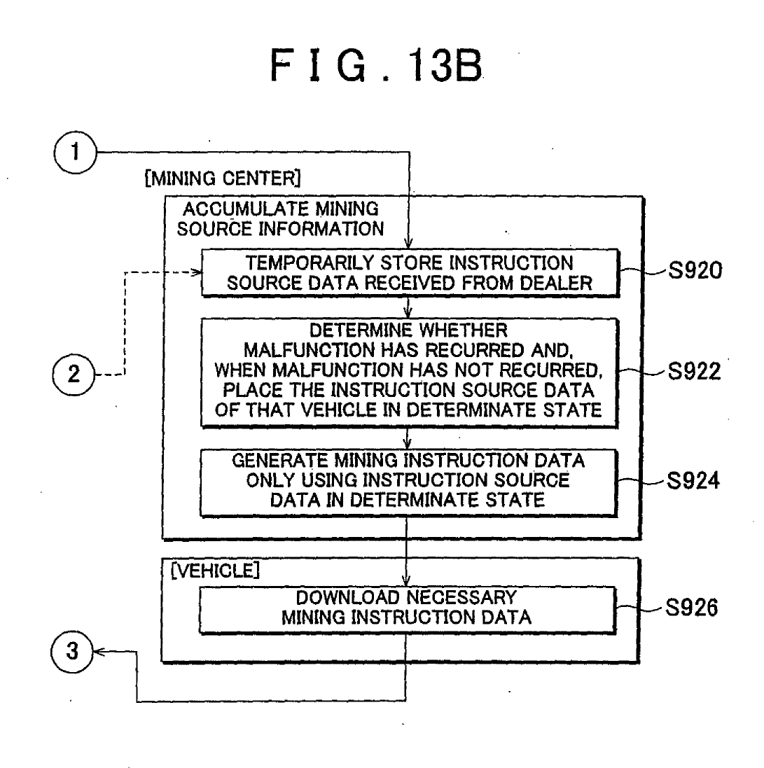

FIG. 13A and FIG. 13B are a flowchart that shows the flow of a failure diagnostic support scheme implemented by the vehicle repair support system 13 according to the third embodiment.

In step 900, in-vehicle ECUs, which are elements of the various electronic devices 202 of the in-vehicle device 201 of a vehicle, carry out self-malfunction diagnosis of the in-vehicle device 201. When the in-vehicle ECUs detect self-malfunction, the in-vehicle ECUs transmit a warning signal to the master control device 208.

In step 902, the master control device 208 of the in-vehicle device 201 of the vehicle lights or blinks a warning lamp (typically, an indicator lamp in the indicator) of the information output device 206 in response to the warning signal transmitted from any one of the in-vehicle ECUs, which are elements of the various electronic devices 202.

In step 904, the master control device 208 of the in-vehicle device 201 of the vehicle transmits FFD and a DTC, acquired in connection with the current warning signal, together with identification information to the center server 301. These pieces of information (particularly, DTC and identification information) are used to determine recurrence of malfunction in the center server 301 (see step 922). Thus, the master control device 208 may omit the transmission to the center server 301 when the current DTC is a new type DTC that has not ever been experienced.

In step 906, the master control device 208 of the in-vehicle device 201 of the vehicle determines, on the basis of the DTC acquired in connection with the current warning signal, whether the malfunction is a mining target. For example, the master control device 208 accesses the information database 210 to determine whether a piece of mining instruction data corresponding to the current DTC is present in the information database 210. In the present embodiment, the following description refers to the case in which the malfunction is a mining target. If the malfunction is not a mining target, the master control device 208 may provide notification that mining is not possible to a user through the information output device 206. In this case, when the user drives the vehicle to a dealer, a service man identifies the root cause of the malfunction by a selected method to repair the vehicle at the dealer, and then carries out step 918, which will be described later, after the repair.

In step 908, the master control device 208 of the in-vehicle device 201 of the vehicle acquires information about the FFD characteristic quantity in the FFD acquired in connection with the current warning signal. The process in step 908 may be similar to the process described in regard to step 712 of FIG. 4A in the above described first embodiment.

In step 910, the master control device 208 of the in-vehicle device 201 of the vehicle extracts pieces of data that are the most approximate to the currently acquired FFD characteristic quantity from the mining instruction data in the information database 210, and estimates pieces of root cause information connected with the mining instruction data as candidates for the root cause information corresponding to the current malfunction in decreasing order of the degree of approximation. The process of step 910 may be similar to the process described in regard to step 714 of FIG. 4A in the above described first embodiment, except that the mining instruction data in the information database 210 at the vehicle side are used instead of the instruction information database 304 at the center server 301 side.

In step 912, the master control device 208 of the in-vehicle device 201 of the vehicle outputs the mining results (the results of estimating candidates for root cause information) through the information output device 206 (for example, display) (see FIG. 9).

In step 914, the vehicle user who sees the mining results voluntarily drives the vehicle to a dealer and requests the dealer for check and repair. At this time, the user shows the mining results, output onto the information output device 206, to a service man at the dealer.

In step 916, the service man at the dealer refers to the mining results to conduct repair. The repair is conducted until the malfunction is eliminated at that moment. However, as will be described later, the accuracy of the mining results increases as the mining instruction data are accumulated in the instruction information database 304 (and, in accordance with this, the mining instruction data are accumulated in the information database 210). This increases reliability of repair and, therefore, prevents a situation in which the root cause of malfunction cannot be identified causing the repair of the vehicle to take a long time.

In step 918, the information management unit 403 of the dealer terminal 401 transmits instruction source data to the center server 301. The instruction source data contain the mining source data (FFD, DTC and identification information acquired in connection with the current warning signal) and the root cause information connected with the malfunction that is currently eliminated by repair. Note that the mining source data have been already transmitted to the center server 301 (see step 904). Thus, the root cause information connected with the malfunction that is currently eliminated by repair may be transmitted to the center server 301 so that the root cause information can be associated with the already transmitted mining source data. In addition, the root cause information transmitted in step 918 is input by the service man to the dealer terminal 401 through the user interface 406. Alternatively, the root cause information may be transmitted from the in-vehicle device 201 to the center server 301 so that the root cause information can be associated with the already transmitted mining source data. In this case, the root cause information may be input by the service man through the user interface (not shown) of the in-vehicle device 201 or may be input by the user through the user interface (not shown) of the in-vehicle device 201. Note that in this case, the dealer terminal 401 at the dealer is not necessary and, therefore, the dealer terminal 401 may be omitted.

In step 918, when the root cause information (including candidates) taught by the mining results is inappropriate, that is, when it is found from a repair that the root cause is different from the taught root cause information, the found root cause information is transmitted to the center server 301. In addition, it is also applicable that, when the root cause information (particularly, a first candidate) taught by the mining results is appropriate as well, that root cause information is transmitted to the center server 301.

In step 920, the information management unit 305 of the center server 301 temporarily stores the instruction source data, received from the dealer terminal 401 (or the in-vehicle device 201) in step 918, in the indeterminate information database 303. Note that the temporarily stored instruction source data are initially placed in indeterminate state, and the instruction source data are not used to generate mining instruction data until the instruction source data are placed in determinate state, as will be described later.

In step 922, the information management unit 305 of the center server 301 determines whether the same malfunction has recurred in the same vehicle after the current repair, and changes the instruction source data of that vehicle to a determinate state when the same malfunction has not recurred. On the other hand, when the same malfunction has recurred, the information management unit 305 deletes (discards) the instruction source data of that vehicle from the indeterminate information database 303. The process in step 922 may be similar to the process described in regard to step 724 of FIG. 4B in the above described first embodiment.

In step 924, the information management unit 305 of the center server 301 uses only the determinate instruction source data among the instruction source data that are temporarily stored in the indeterminate information database 303 to generate mining instruction data. The information management unit 305 stores the generated mining instruction data in the instruction information database 304 in order to use the data for future mining (see steps 906 to 912). The process in step 924 may be similar to the process described in regard to step 726 of FIG. 4B in the above described first embodiment.

In step 926, the master control device 208 of the in-vehicle device 201 of the vehicle downloads the mining instruction data stored in the instruction information database 304 from the center server 301. The master control device 208 stores the downloaded mining instruction data in the information database 210 in order to use the data for future mining (see steps 906 to 912). Note that the mining instruction data may be supplied through downloading from the center server 301 side to the vehicle side in response to a request from the vehicle side and/or may be supplied through downloading from the center server 301 side to the vehicle side at a predetermined timing irrespective of whether a request is issued from the vehicle side. In the former case, for example, when receiving the warning signal in step 902, the master control device 208 may access the center server 301 to download the mining instruction data. In this case, mining instruction data for downloading may be only the mining instruction data connected with the current warning signal (or DTC). In the latter case, the predetermined timing may be a timing at which the mining instruction data in the instruction information database 304 are updated (changed, added, or the like) or may be a fixed timing (for example, every one month). In this case as well, the mining instruction data downloaded from the center server 301 side are not necessarily all the mining instruction data in the instruction information database 304 but may be only the necessary mining instruction data in the instruction information database 304.

In addition, it is also applicable that, in step 926, the master control device 208 carries out mining using the mining instruction data in the information database 210 in the above steps 906 to 912 and, when accurate mining results are not obtained, downloads additional mining instruction data (for example, detailed mining instruction data) from the center server 301. In addition, it is also applicable that, when the current malfunction is not a mining target for the mining instruction data in the information database 210 (see step 906), similarly, additional mining instruction data (for example, detailed mining instruction data) are downloaded from the center server 301.

According to the above described third embodiment, as in the case of the above described first embodiment, mining instruction data are generated only using accurate instruction source data. As a result, reliability (accuracy) of mining instruction data improves and, therefore, reliability (accuracy) of mining results improves.

Note that the third embodiment may be implemented appropriately in combination with the above described first embodiment. For example, in consideration of processing load or capacity limitations at the vehicle side, mining instruction data downloaded into the information database 210 may be limited to a predetermined data size. Then, as described above, when a warning signal occurs, mining may be executed first using the mining instruction data in the information database 210 in accordance with the third embodiment. When accurate mining results are not obtained, mining results generated using the mining instruction data in the instruction information database 304 at the center server 301 side may be requested in accordance with the first embodiment.

The vehicle repair support system 14 has the arrangement of the fourth embodiment so that the above described functions 20 to 24 are mainly implemented by the center server 301 as in the case of the first embodiment. The fourth embodiment mainly differs from the first embodiment in that the mining function 25 is mainly implemented at a dealer side.

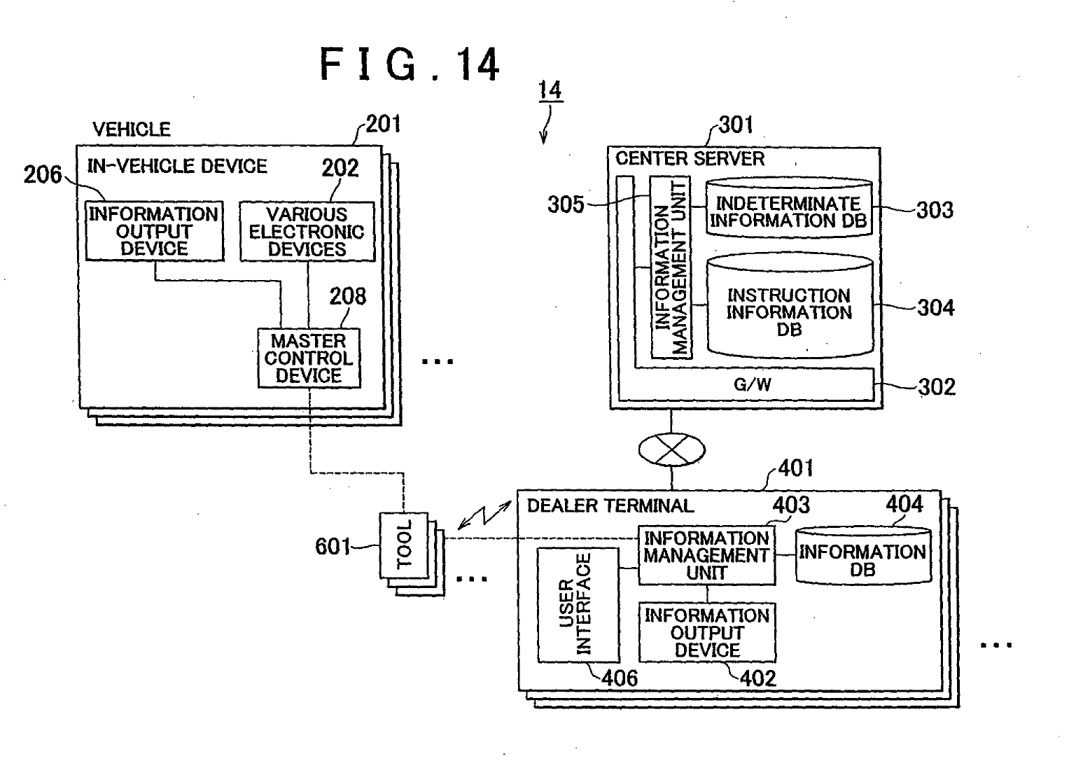

FIG. 14 is a system configuration diagram that shows the relevant configuration of the vehicle repair support system 14. Like reference numerals denote like components to those of the first embodiment, and the description thereof is omitted where appropriate.

As shown in FIG. 14, each in-vehicle device 201 includes the various electronic devices 202, the information output device 206 and the master control device 208. The center server 301 includes the network gateway 302, the indeterminate information database 303, the instruction information database 304 and the information management unit 305. Each dealer terminal 401 includes the information output device 402, the information management unit 403, an information database (DB) 404 and the user interface 406. The information database 404 stores mining instruction data acquired through downloading from the center server 301, as will be described later.

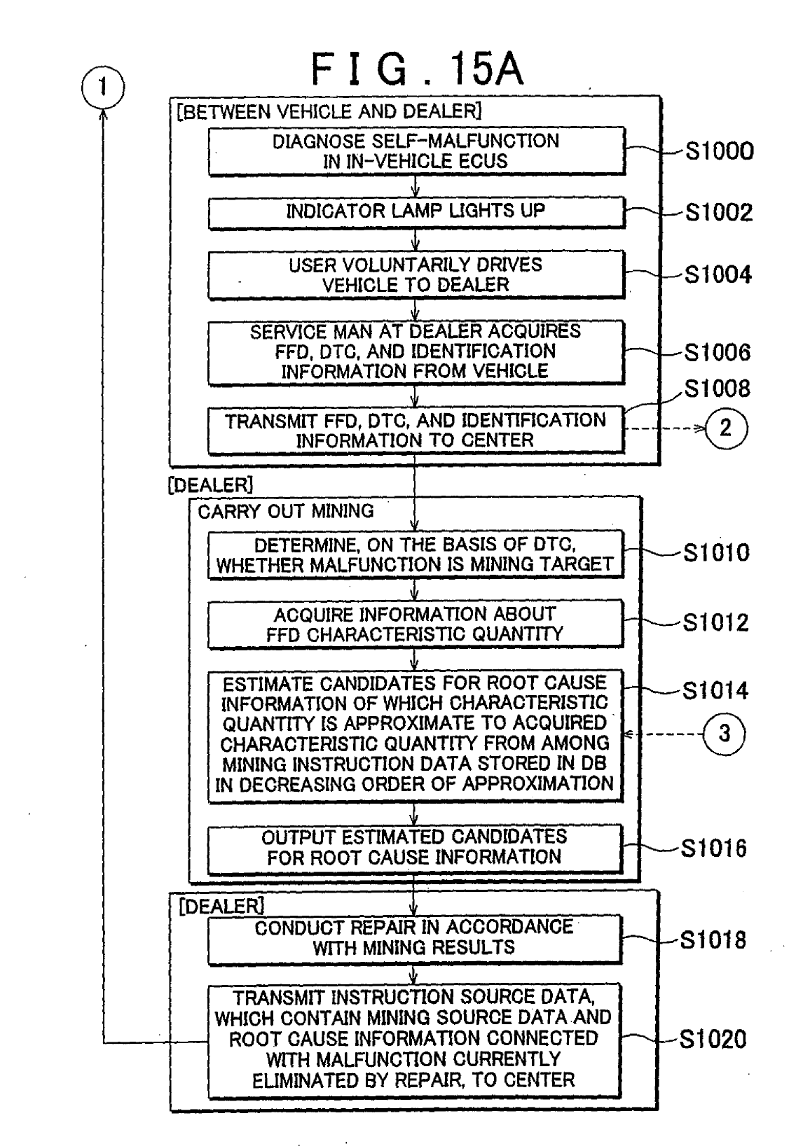

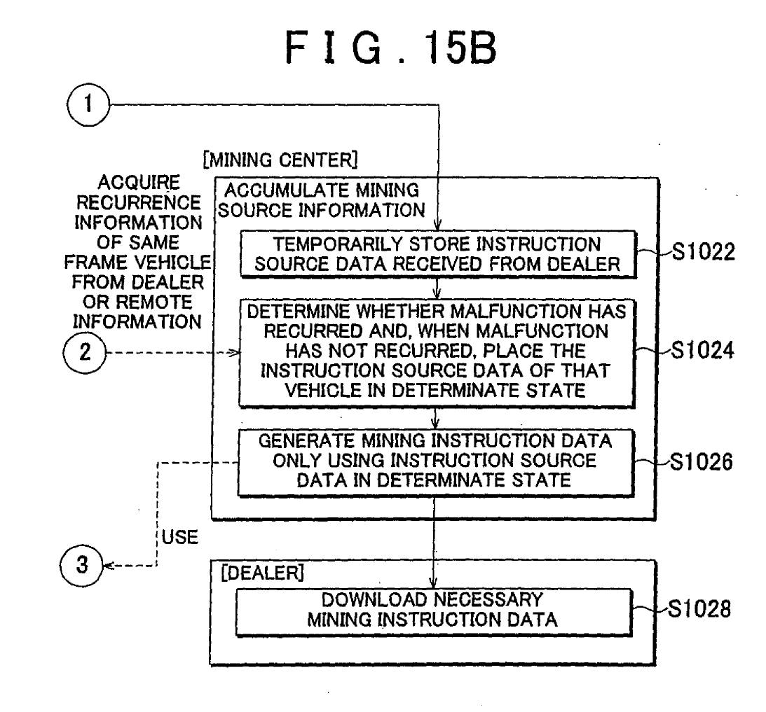

FIG. 15A and FIG. 15B are a flowchart that shows the flow of a failure diagnostic support scheme implemented by the vehicle repair support system 14 according to the fourth embodiment.

In step 1000, in-vehicle ECUs, which are elements of the various electronic devices 202 of the in-vehicle device 201 of a vehicle, carry out self-malfunction diagnosis of the in-vehicle device 201. When the in-vehicle ECUs detect self-malfunction, the in-vehicle ECUs transmit a warning signal to the master control device 208.

In step 1002, the master control device 208 of the in-vehicle device 201 of the vehicle lights or blinks a warning lamp (typically, an indicator lamp in the indicator) of the information output device 206 in response to the warning signal transmitted from any one of the in-vehicle ECUs, which are elements of the various electronic devices 202.

In step 1004, a vehicle user who recognizes blinking of the warning lamp voluntarily drives the vehicle to a dealer and requests the dealer for check and repair.

In step 1006, a service man at the dealer uses the tool 601 (see FIG. 14) to acquire FFD, a DTC and identification information from the vehicle. The tool 601 is typically supplied from a carmaker to each dealer. The tool 601 is presumably used by a technical service man at a dealer and may be a compact terminal that can be carried with a person for operation. Note that the tool 601 may require authentication, such as password input or ID check, for use in order to prevent an unauthorized person from using the tool 601. When the tool 601 is connected to a predetermined connection terminal provided for a vehicle, the tool 601 acquires FFD, a DTC and identification information from the vehicle. The tool 601 may acquire various pieces of information through wireless communication (for example, narrow-band communication).

In step 1008, the information management unit 403 of the dealer terminal 401 transmits the FFD, DTC and identification information, acquired by the tool 601 in step 1006, to the center server 301. Note that the FFD, DTC and identification information may be directly transmitted from the tool 601 to the center server 301. These pieces of information (particularly, DTC and identification information) are used to determine recurrence of malfunction in the center server 301 (see step 1024). Thus, the transmission to the center server 301 may be omitted when the current DTC is a new type DTC that has not ever been experienced.

In step 1010, the information management unit 403 of the dealer terminal 401 determines, on the basis of the DTC acquired in connection with the current warning signal, whether the malfunction is a mining target. For example, the information management unit 403 accesses the information database 404 in the dealer terminal 401 to determine whether a piece of mining instruction data corresponding to the current DTC is present in the information database 404. In the present embodiment, the following description refers to the case in which the malfunction is a mining target. If the malfunction is not a mining target, the information management unit 403 may provide notification that mining is not possible to a service man at the dealer through the information output device 402. In this case, the service man identifies the root cause of the malfunction by a selected method to repair the vehicle at the dealer, and then carries out step 1020, which will be described later, after the repair.

In step 1012, the information management unit 403 of the dealer terminal 401 acquires information about the FFD characteristic quantity of the FFD acquired in connection with the current warning signal. The process in step 1012 may be similar to the process described in regard to step 712 of FIG. 4A in the above described first embodiment.

In step 1014, the information management unit 403 of the dealer terminal 401 extracts pieces of data that are the most approximate to the currently acquired FFD characteristic quantity from the mining instruction data in the information database 404, and estimates pieces of root cause information connected with the mining instruction data as candidates for the root cause information corresponding to the current malfunction in decreasing order of the degree of approximation. The process of step 1014 may be similar to the process described in regard to step 714 of FIG. 4A in the above described first embodiment, except that the mining instruction data in the information database 404 at the dealer side are used instead of the instruction information database 304 at the center server 301 side.

In step 1016, the information management unit 403 of the dealer terminal 401 outputs the mining results (the results of estimating candidates for root cause information) through the information output device 402 (for example, display) (see FIG. 9).

In step 1018, the service man at the dealer refers to the mining results to conduct repair. The repair is conducted until the malfunction is eliminated at that moment. However, as will be described later, the accuracy of the mining results increases as the mining instruction data are accumulated in the instruction information database 304 (and, in accordance with this, the mining instruction data are accumulated in the information database 404). This increases reliability of repair and, therefore, prevents a situation in which the root cause of malfunction cannot be identified causing the repair of the vehicle to take a long time.

In step 1020, the information management unit 403 of the dealer terminal 401 transmits instruction source data to the center server 301. The instruction source data contain the mining source data (FFD, DTC and identification information acquired in connection with the current warning signal) and the root cause information connected with the malfunction currently eliminated by repair. Note that the mining source data have been already transmitted to the center server 301 (see step 1008). Thus, the root cause information connected with the malfunction that is currently eliminated by repair may be transmitted to the center server 301 so that the root cause information can be associated with the already transmitted mining source data. In addition, the root cause information transmitted in step 1020 is input by the service man to the dealer terminal 401 through the user interface 406.

In step 1020, when the root cause information (including candidates) taught by the mining results is inappropriate, that is, when it is found from a repair that the root cause is different from the taught root cause information, the found root cause information is transmitted to the center server 301. In addition, it is also applicable that, when the root cause information (particularly, a first candidate) taught by the mining results is appropriate as well, that root cause information is transmitted to the center server 301.

In step 1022, the information management unit 305 of the center server 301 temporarily stores the instruction source data, received from the dealer terminal 401 in step 1020, in the indeterminate information database 303. Note that the temporarily stored instruction source data are initially placed in indeterminate state, and the instruction source data are not used to generate mining instruction data until the instruction source data are placed in determinate state, as will be described later.

In step 1024, the information management unit 305 of the center server 301 determines whether the same malfunction has recurred in the same vehicle thereafter, and changes the instruction source data of that vehicle to a determinate state when the same malfunction has not recurred. On the other hand, when the same malfunction has recurred, the information management unit 305 deletes (discards) the instruction source data of that vehicle from the indeterminate information database 303. The process in step 1024 may be similar to the process described in regard to step 724 of FIG. 4B in the above described first embodiment.

In step 1026, the information management unit 305 of the center server 301 uses only the determinate instruction source data among the instruction source data that are temporarily stored in the indeterminate information database 303 to generate mining instruction data. The information management unit 305 stores the generated mining instruction data in the instruction information database 304 in order to use the data for future mining (see steps 1010 to 1016). The process in step 1026 may be similar to the process described in regard to step 726 of FIG. 4B in the above described first embodiment.

In step 1028, the information management unit 403 of the dealer terminal 401 downloads the mining instruction data stored in the instruction information database 304 from the center server 301. The information management unit 403 stores the downloaded mining instruction data in the information database 404 in order to use the data for future mining (see steps 1010 to 1016). Note that the mining instruction data may be supplied through downloading from the center server 301 side to the dealer terminal 401 side in response to a request from the dealer terminal 401 side and/or may be supplied through downloading from the center server 301 side to the dealer terminal 401 side at a predetermined timing irrespective of whether a request is issued from the dealer terminal 401 side. In the former case, for example, when receiving the warning signal in step 1002, the information management unit 403 of the dealer terminal 401 may access the center server 301 to download the mining instruction data. In this case, mining instruction data for downloading may be only the mining instruction data connected with the current warning signal (or DTC). In the latter case, the predetermined timing may be a timing at which the mining instruction data in the instruction information database 304 are updated (changed, added, or the like) or may be a fixed timing (for example, every one month). In this case as well, the mining instruction data downloaded from the center server 301 side are not necessarily all the mining instruction data in the instruction information database 304 but may be only the necessary mining instruction data in the instruction information database 304.

In addition, it is also applicable that, in step 1028, the information management unit 403 of the dealer terminal 401 carries out mining using the mining instruction data in the information database 404 in the above steps 1010 to 1016 and, when accurate mining results are not obtained, downloads additional mining instruction data (for example, detailed mining instruction data) from the center server 301. In addition, it is also applicable that, when the current malfunction is not a mining target for the mining instruction data in the information database 404 (see step 1010), similarly, additional mining instruction data (for example, detailed mining instruction data) are downloaded from the center server 301.

According to the above described fourth embodiment, as in the case of the above described first embodiment, mining instruction data are generated only using accurate instruction source data. As a result, reliability (accuracy) of mining instruction data improves and, therefore, reliability (accuracy) of mining results improves.

Note that the fourth embodiment may be implemented appropriately in combination with the above described first embodiment. For example, in consideration of processing load or capacity limitations at the dealer terminal 401 side, the data size of mining instruction data stored in the information database 404 may be limited. Then, as described above, when a warning signal occurs, mining may be executed first using the mining instruction data in the information database 404 in accordance with the fourth embodiment. When accurate mining results are not obtained, mining results generated using the mining instruction data in the instruction information database 304 at the center server 301 side may be requested in accordance with the first embodiment.

The embodiments of the invention are described in detail above; however, the aspects of the invention are not limited to the above described embodiments. The aspects of the invention may also be implemented so that various modifications or replacements are applied to the above described embodiments without departing from the scope of the invention.

For example, in the above described embodiments, the root cause information that constitute the mining instruction data indicates the cause (root cause) of the malfunction. The root cause information may employ another piece of information connected with the root cause information instead of or in addition to the root cause information. For example, information that indicates the content of repair (including the content of component replacement) by which the malfunction is eliminated may be used instead of or in addition to the root cause information.

In addition, in the above described embodiments, candidates for root cause information are output as mining results. The mining results may contain another piece of information connected with the root cause information instead of or in addition to the root cause information. For example, information that indicates the content of past repair (including the content of past component replacement) by which a malfunction connected the root cause information is eliminated may be output as mining results instead of or in addition to the root cause information.

In addition, in the above described embodiments, mining instruction data are generated when the malfunction has not recurred. Instead, mining instruction data may be generated irrespective of recurrence of malfunction. However, in this case, the generated mining instruction data are limitedly managed so that the mining instruction data are used for failure diagnosis only if the malfunction has not recurred. That is, the generated mining instruction data are handled as temporary mining instruction data until it is determined that the malfunction has not recurred. In this case, in the above described first and second embodiments, the temporary mining instruction data are prohibited from use for mining. In the above described third and fourth embodiments, the temporary mining instruction data are prohibited from downloading or prohibited from use for mining in the in-vehicle device 201 and/or the dealer terminal 401 if downloaded.

In addition, in the above described embodiments, it is determined, mainly on the basis of the DTC, whether the same malfunction has recurred. Instead, it may also be determined, on the basis of another piece of information (for example, FFD, or the like, whether the malfunction has recurred, and information used for determination of recurrence of malfunction may be selected.

In addition, in the above described embodiments, the indeterminate information database 303 is arranged at the center server 301 side, and instruction source data are transmitted to the center server 301 irrespective of recurrence of malfunction; however, the aspects of the invention are not limited to this configuration. For example, it is also applicable that instruction source data are temporarily stored in the in-vehicle device 201 and/or dealer terminal 401 and, only when the malfunction has not recurred, the temporarily stored instruction source data are transmitted to the center server 301. That is, the function of the indeterminate information database 303 may be implemented by the in-vehicle device 201 and/or the dealer terminal 401. In this case, the information management unit 305 of the center server 301 may determine that the same malfunction has not recurred when instruction source data are supplied from the in-vehicle device 201 and/or the dealer terminal 401, to generate mining instruction data on the basis of the supplied instruction source data. That is, in this case, supply of instruction source data from the in-vehicle device 201 and/or the dealer terminal 401 serves as information that indicates that the malfunction has not recurred. Instead, instruction source data may be transmitted to the center server 301 with redundant information that indicates that the malfunction has not recurred.

In addition, the above embodiments describe the example in which a failure of the A sensor system, a failure of the B switch system and a failure of the D actuator as candidates for root cause information. Instead, root cause information used for candidates may be further lower level root cause information (for example, a failure of a detailed portion in the A sensor system, or the like) or may be further upper level root cause information (for example, a failure of an E system or E function that include the D actuator, or the like).

In addition, in the above described embodiments, mining instruction data are generated in consideration of recurrence of malfunction as described above. Thus, the accuracy of mining results (particularly, a first candidate) obtained on the basis of the mining instruction data should be high. If the same malfunction recurs even when repair is conducted in accordance with the mining results, mining instruction data by which the mining results are derived (and instruction source data in determinate state based on which the mining instruction data are generated) may be discarded.

In addition, in the above described embodiments, portion of or the entire function of the center server 301 may be implemented by the in-vehicle device 201. For example, the center server 301 may be removed or maintained while the entire function of the center server 301 may be implemented by the in-vehicle device 201 of a specific vehicle. In this case, the specific vehicle substantially serves as a mobile center server. In addition, for example, the center server 301 may be removed or maintained while the entire function of the center server 301 may be implemented by each of the in-vehicle devices 201 of a plurality of vehicles. In this case, mining instruction data may be generated using information through inter-vehicle communication, or the like. In addition, the generated mining instruction data may be used not only to identify the root cause information of a malfunction of a host vehicle but also to identify the root cause information of a malfunction of another vehicle.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. (canceled)

2. The failure diagnostic information generating apparatus according to claim 21, wherein, when it is determined that the malfunction has not recurred by the time when a predetermined period elapses from the repair or component replacement of the vehicle or by the time when the vehicle runs a predetermined distance, the instruction information generating device generates the instruction information on the basis of the repair information and malfunction-time vehicle information that are connected with the malfunction that has not recurred or determines to use the instruction information for future repair or component replacement, the instruction information being generated by the instruction information generating device on the basis of the repair information and malfunction-time vehicle information that are connected with the malfunction that has not recurred.

3. The failure diagnostic information generating apparatus according to claim 21, wherein, when it is determined that the malfunction has recurred by the time when a predetermined period elapses from the repair or component replacement of the vehicle or by the time when the vehicle runs a predetermined distance, the instruction information generating device does not generate the instruction information on the basis of the repair information and malfunction-time vehicle information that are connected with the malfunction that has recurred or determines not to use the instruction information for future repair or component replacement, the instruction information being generated by the instruction information generating device on the basis of the repair information and malfunction-time vehicle information that are connected with the malfunction that has not recurred.

4. The failure diagnostic information generating apparatus according to claim 21, wherein:
only when it is determined that the malfunction has not recurred by the time when a predetermined period elapses from the repair or component replacement of the vehicle or by the time when the vehicle runs a predetermined distance, the repair information acquiring device acquires the repair information connected with the malfunction that has not recurred, and the malfunction-time vehicle information acquiring device acquires the malfunction-time vehicle information; and
the instruction information generating device generates the instruction information on the basis of the acquired repair information and malfunction-time vehicle information.

5. The failure diagnostic information generating apparatus according to claim 3, wherein, when it is determined that the malfunction has recurred by the time when a predetermined period elapses from the repair or component replacement of the vehicle or by the time when the vehicle runs a predetermined distance, the instruction information generating device discards the repair information and malfunction-time vehicle information that are connected with the malfunction that has recurred and, when instruction information connected with the malfunction that has recurred has been generated, discards the instruction information connected with the malfunction that has recurred.

6. The failure diagnostic information generating apparatus according to claim 21, wherein, only when it is determined that the malfunction has not recurred by the time when a predetermined period elapses from the repair or component replacement of the vehicle or by the time when the vehicle runs a predetermined distance, the instruction information generating device provides the instruction information connected with the malfunction that has not recurred to a vehicle repair support apparatus that is installed in at least any one of a vehicle, a dealer and a repair facility.

7. The failure diagnostic information generating apparatus according to claim 21, wherein the recurrence information acquiring device acquires the recurrence information from at least any one of a vehicle, a dealer and a repair facility, or the recurrence information acquiring device acquires post-repair vehicle information that indicates a vehicle state of the vehicle after the repair or component replacement of the vehicle from at least any one of a vehicle, a dealer and a repair facility and then determines, on the basis of the acquired post-repair vehicle information, whether the malfunction has recurred to thereby acquire the recurrence information.

8. The failure diagnostic information generating apparatus according to claim 21, further comprising repair support information generating device that generates repair support information useful for repair or component replacement to a new malfunction on the basis of malfunction-time vehicle information, acquired when the new malfunction occurs, and the instruction information.

9. The failure diagnostic information generating apparatus according to claim 8, wherein the repair support information contains at least any one of information that indicates the content of repair or component replacement to be conducted and root cause information that indicates a cause of the new malfunction.

10. A vehicle repair support apparatus installed in at least any one of a vehicle, a dealer and a repair facility, comprising:
instruction information acquiring device that acquires the instruction information from the failure diagnostic information generating apparatus according to claim 6;
malfunction-time vehicle information acquiring device that acquires malfunction-time vehicle information that indicates a vehicle state detected when the malfunction occurs in a vehicle; and
repair support information output device that generates and outputs repair support information useful for repair or component replacement to the malfunction on the basis of the acquired malfunction-time vehicle information and the acquired instruction information.

11. A vehicle repair support apparatus installed in at least any one of a vehicle, a dealer and a repair facility, comprising:
repair support information output device that acquires and outputs the repair support information from the failure diagnostic information generating apparatus according to claim 8.

12. The vehicle repair support apparatus according to claim 10, wherein the repair support information contains at least any one of information that indicates the content of repair or component replacement to be conducted and root cause information that indicates a cause of the new malfunction.

13. A vehicle repair support system comprising:
the failure diagnostic information generating apparatus according to claim 6; and
the vehicle repair support apparatus according to claim 10.

14. A failure diagnostic information generating system comprising:
the failure diagnostic information generating apparatus according to claim 21; and
a recurrence information providing apparatus,
wherein the recurrence information providing apparatus includes post-repair vehicle information acquiring device that acquires post-repair vehicle information that indicates a vehicle state of the vehicle after the repair or component replacement of that vehicle; determining device that determines, on the basis of the acquired post-repair vehicle information, whether the malfunction has recurred; and transmitting device that generates the recurrence information on the basis of the result determined by the determining device and that transmits the generated recurrence information to the failure diagnostic information generating apparatus.

15. The failure diagnostic information generating system according to claim 14, wherein, only when the determining device determines that the malfunction has not recurred, the transmitting device transmits the repair information and malfunction-time vehicle information, which are connected with the malfunction that has not recurred, to the failure diagnostic information generating apparatus, and the transmission of the repair information and malfunction-time vehicle information serves as the recurrence information.

16. The failure diagnostic information generating system according to claim 14, wherein the post-repair vehicle information acquiring device, the determining device and the transmitting device are installed in at least any one of a vehicle, a dealer and a repair facility.

17. (canceled)

18. A failure diagnostic information generating method comprising:
acquiring repair information that indicates the content of repair or component replacement conducted in connection with a malfunction of a vehicle or a cause of the malfunction;
acquiring malfunction-time vehicle information that indicates a vehicle state detected when the malfunction occurs;
acquiring recurrence information that indicates whether the malfunction, that has once resolved by the repair or component replacement of the vehicle, has recurred after the repair or component replacement of the vehicle; and
when it is determined, on the basis of the recurrence information, that the malfunction has not recurred, generating instruction information usable for future repair or component replacement on the basis of the repair information and the malfunction-time vehicle information.

19. A database comprising:
the instruction information generated by the failure diagnostic information generating apparatus according to claim 21.

20. A database installed in at least any one of a vehicle, a dealer and a repair facility, comprising:
the instruction information supplied from the failure diagnostic information generating apparatus according to claim 6.

21. A failure diagnostic information generating apparatus comprising:
repair information acquiring device that acquires repair information that indicates the content of repair or component replacement conducted in connection with a malfunction of a vehicle or a cause of the malfunction;
malfunction-time vehicle information acquiring device that acquires malfunction-time vehicle information, the malfunction-time vehicle information indicating a vehicle state detected when the malfunction occurs;
instruction information generating device that generates instruction information, usable for future repair or component replacement, on the basis of the repair information and the malfunction-time vehicle information; and
recurrence information acquiring device that acquires recurrence information that indicates whether the malfunction, that has once resolved by the repair or component replacement of the vehicle, has recurred after the repair or component replacement of the vehicle,
wherein when it is determined, on the basis of the recurrence information, that the malfunction has not recurred after the repair or component replacement of the vehicle, the instruction information generating device generates the instruction information on the basis of the repair information and malfunction-time vehicle information that are connected with the malfunction that has not recurred or determines to use the instruction information for future repair or component replacement, the instruction information being generated by the instruction information generating device on the basis of the repair information and malfunction-time vehicle information that are connected with the malfunction that has not recurred.

22. The vehicle repair support apparatus according to claim 11, wherein the repair support information contains at least any one of information that indicates the content of repair or component replacement to be conducted and root cause information that indicates a cause of the new malfunction.

23. A vehicle repair support system comprising:
the failure diagnostic information generating apparatus according to claim 6; and
the vehicle repair support apparatus according to claim 11.
